(19) United States
(12) Patent Application Publication
(10) Pub. No.: US 2011/0101287 A1
(43) Pub. Date: May 5, 2011

(54) OPTICAL FILM, METHOD FOR PRODUCING SAME, POLARIZER AND LIQUID CRYSTAL DISPLAY DEVICE

(75) Inventors: Jun TAKEDA, Minami-ashigara-shi (JP); Takahiro OHNO, Minami-ashigara-shi (JP); Akira IKEDA, Minami-ashigara-shi (JP)

(73) Assignee: FUJIFILM CORPORATION, Tokyo (JP)

(21) Appl. No.: 12/914,696

(22) Filed: Oct. 28, 2010

(30) Foreign Application Priority Data
Oct. 30, 2009 (JP) 2009-251231
Sep. 16, 2010 (JP) 2010-208014

(51) Int. Cl. G02F 1/361

(52) U.S. Cl. 252/582

(57) ABSTRACT

An optical film comprising a cellulose acylate resin having a total degree of acyl substitution of less than 2.5 and a cellulose acylate resin having a total degree of acyl substitution of 2.5 or more, and satisfying the following formula (1):

|A−B|×(b/a)≦0.13 (1)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

### CROSS-REFERENCE TO RELATED APPLICATIONS

The present application claims the benefit of priority from Japanese Patent Application No. 2009-251231, filed on Oct. 30, 2009, and Japanese Patent Application No. 2010-208014, filed on Sep. 16, 2010, the contents of which are herein incorporated by reference in their entirety.

### BACKGROUND OF THE INVENTION

1. Field of the Invention

The present invention relates to an optical film, a method for producing it, a polarizer and a liquid crystal display device. In particular, the invention relates to an optical film comprising at least two types of cellulose acylate resins that differ in the total degree of acyl substitution therein, and to a method for producing the film.

2. Description of the Related Art

Heretofore, as the protective film for polarizer, used is a film comprising, as the main ingredient thereof, a cellulose acylate resin; and such an ordinary cellulose acylate resin-containing optical film is produced according to a solution casting method (see JP-A 2003-73485, 2007-146190, 2007-256982). Recently, various modes of liquid crystal cells have been developed, and with that, the optical expressibility necessary for optical films for polarizer protection in liquid crystal display devices has become diversified. In addition, further reduction in the production cost for such optical films is desired. Accordingly, desired is a method for reducing the overall production method for various optical films having various optical properties.

As a method for reducing the production cost for ordinary cellulose films, there are known a method of increasing the latitude in the fluctuation of the total degree of acyl substitution in the cellulose acylate resin to be used as the starting material, and a method of recycling film scraps in casting film formation.

As the former method, known is a method of blending at least two types of cellulose acylate resins that differ in the total degree of acyl substitution therein (see JP-A 2003-73485, 2007-146190). Blending cellulose acylates that differ in the degree of substitution therein and in the type of the substituent according to the method could provide a biaxial optical film of which the optical properties such as the in-plane retardation and the thickness-direction retardation thereof are optimized, and using the optical film of the type could provide a liquid crystal display device having the advantage of broadened viewing angle characteristics, for example, as described in JP-A 2003-73485.

As the latter method, known is a method of using, as the starting material therein, a cellulose acetate resin having a degree of acetylation of 61.0% and a material prepared by grinding and collecting a cellulose acetate film having a degree of acetylation of 61.0%, and casting it in a mode of solution casting (see JP-A 2007-256982). In this method, the broken material of cellulose acylate film can be used in an amount of from 10 to 70% by mass of the total material, as so described in the patent reference; however, in this, the degree of acetylation of the cellulose resin to be used as the starting material is all the time constant. In other words, in the patent reference, nothing is discussed relating to use of at least two types of cellulose acylate resins that differ in the total degree of acyl substitution therein.

On the other hand, recently, from the viewpoint of controlling the optical properties such as the in-plane retardation and the thickness-direction retardation of an optical film, aggressive use of a cellulose acylate resin having a low degree of substitution (for example, having a total degree of acyl substitution of less than 2.5) has become investigated. However, in general, when such a cellulose acylate resin having a low degree of substitution is formed into a film in a mode of solution casting, it is known that the formed film is difficult to peel from the metal support. For example, in case where SUS is used for the metal support, the cellulose resin having a low degree of substitution has a terminal —OH group existing in the film surface and therefore brings about interaction with SUS, and it is expected that the film peelability is not good. Accordingly, the optical film produced by aggressive use of such a cellulose acylate resin having a low degree of substitution (for example, having a total degree of substitution of less than 2.5) and its production method are still unsatisfactory in practical use thereof.

The present inventors have investigated the methods described in JP-A 2003-73485 and 2007-146190, and have found that, when two or more types of cellulose acylate resins differing in the center value of the total degree of acyl substitution therein are selected and combined with no limitation thereon for use in solution casting to form a film, then the formed film is whitened in many cases. The inventors have further found that, when the method described in JP-A 2007-256982 is applied to an embodiment where two or more types of cellulose acylate resins differing in the total degree of acyl substitution therein are contained in the starting material dope, then the film prepared by the use of the scrapped material is whitened, and as compared with the case where a cellulose acylate resin having the same degree of acetylation is simply recycled, the method requires additional investigations.

### SUMMARY OF THE INVENTION

The present invention is to solve the above-mentioned problems. Specifically, the subject matter of the invention is to provide an optical film which contains at least a cellulose acylate rein having a total degree of acyl substitution of less than 2.5, which peels well from the metal support in solution casting to form it, which does not whiten and which has good optical expressibility, and to provide a cost-reduced production method for the optical film.

With the above-mentioned problems, the present inventors have assiduously studied and, as a result, have found that, when a cellulose acylate resin having a total degree of acyl substitution of less than 2.5 is combined with a cellulose acylate resin having a total degree of acylation of 2.5 or more and when the proportion of the cellulose acylate resin falling within a specific range is controlled, then the film from the resin mixture well peels from the metal support in solution casting in forming it, and the film does not whiten and its optical expressibility is good. Specifically, the inventors have found that the optical film of the type can be produced at a low production cost, and have completed the present invention.

Concretely, providing the following means, the inventors have solved the above-mentioned problems.

[1] An optical film comprising at least two types of cellulose acylate resins differing from each other in the total degree of acyl substitution therein, wherein the at least two types of cellulose acylate resins include a cellulose acylate resin having a total degree of acyl substitution of less than 2.5 and a cellulose acylate resin having a total degree of acyl substitution of 2.5 or more, and of all the cellulose acylate resins constituting the optical film, the cellulose acylate resin having the largest mass abundance ratio and the cellulose acylate resin having the second largest mass abundance ratio satisfy the following formula (1):

|A−B|×(b/a)≦0.13 (1)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.
[2] The optical film of [1] comprising at least three types of cellulose acylate resins differing from each other in the total degree of acyl substitution therein, wherein, of all the cellulose acylate resins constituting the optical film, the cellulose acylate resin having the largest mass abundance ratio and the cellulose acylate resin having the third largest mass abundance ratio satisfy the following formula (2), and the mass abundance ratio of the cellulose acylate resin having the third largest mass abundance ratio is at least 2.5%:

|A−C|×(c/a)≦0.13 (2)

wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.
[3] The optical film of [1] or [2], wherein, of all the cellulose acylate resins constituting the optical film, the cellulose acylate resin having the largest mass abundance ratio and all the cellulose acylate resins having a mass abundance ratio of at least 2.5% satisfy the following formula (3):

|A−D|×(d/a)≦0.13 (3)

wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.
[4] The optical film of any one of [1] to [3], wherein, of all the cellulose acylate resins constituting the optical film, all the cellulose acylate resins having a mass abundance ratio of at least 20% satisfy the following formula (A):

|P−Q|×(q/p)≦0.13 (A)

wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.
[5] The optical film of any one of [1] to [4], wherein the film center part separated from both surfaces of the film by at least 20% in the film thickness direction comprises at least two types of cellulose acylate resins differing from the total degree of acyl substitution therein, and of the cellulose acylate resins constituting the film center part, the cellulose acylate resin having the largest mass abundance ratio and the cellulose acylate resin having the second largest mass abundance ratio satisfy the following formula (4):

|A−B|×(b/a)≦0.10 (4)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.
[6] The optical film of [5], wherein the film center part comprises at least three types of cellulose acylate resins differing from each other in the total degree of acyl substitution therein, of all the cellulose acylate resins constituting the film center part, the cellulose acylate resin having the largest mass abundance ratio and the cellulose acylate resin having the third largest mass abundance ratio satisfy the following formula (5), and the mass abundance ratio of the cellulose acylate resin having the third largest mass abundance ratio is at least 2.5%:

|A−C|×(c/a)≦0.10 (5)

wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.
[7] The optical film of [5] or [6], wherein, of all the cellulose acylate resins constituting the film center part, the cellulose acylate resin having the largest mass abundance ratio and all the cellulose acylate resins having a mass abundance ratio of at least 2.5% satisfy the following formula (6):

|A−D|×(d/a)≦0.13 (6)

wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.
[8] The optical film of any one of [5] to [7], wherein, of all the cellulose acylate resins constituting the film center part, all the cellulose acylate resins having a mass abundance ratio of at least 20% satisfy the following formula (B):

|P−Q|×(q/p)≦0.13 (B)

wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.
[9] The optical film of any one of [1] to [8], wherein any one of the cellulose acylate resin having the largest mass abundance ratio and the cellulose acylate resin having the second largest mass abundance ratio is a cellulose acylate resin having a total degree of acyl substitution of less than 2.5, and the other is a cellulose acylate resin having a total degree of acyl substitution of 2.5 or more.
[10] The optical film of any one of [1] to [8], wherein the cellulose acylate resin having the largest mass abundance ratio is a cellulose acylate resin having a total degree of acyl substitution of less than 2.5, and the cellulose acylate resin having the second largest mass abundance ratio is a cellulose acylate resin having a total degree of acyl substitution of 2.5 or more.
[11] The optical film of any one of [1] to [10] comprising at least two layers, wherein the mean value Z of the total degree of acyl substitution in the cellulose acylate resin constituting the layer having the largest thickness satisfies the following formula (7):

2.1<Z<2.5. (7)

[12] The optical film of any one of [1] to [11] comprising at least two layers, wherein the outermost layer on at least one side of the film is a cellulose acylate layer having a total degree of acyl substitution of at least 2.5 on average.
[13] The optical film of any one of [1] to [12] comprising at least three layers, wherein the outermost layer on both sides of the film is a cellulose acylate layer having a total degree of acyl substitution of at least 2.5 on average.
[14] The optical film of any one of [1] to [13] containing a phosphate compound or a non-phosphate polyester compound.
[15] The optical film of any one of [1] to [14], wherein the cellulose acylate resin is a cellulose acetate.
[16] The optical film of any one of [1] to [15] not containing an adhesive or an agglutinant.
[17] A method for producing an optical film comprising dissolving at least two types of cellulose acylate resins that differ from each other in the total degree of acyl substitution therein, in a solvent to prepare a dope, and casting the dope onto a metal support to form a film thereon, wherein the cellulose acylate resins include a cellulose acylate resin having a total degree of acyl substitution of less than 2.5 and a cellulose acylate resin having a total degree of acyl substitution of 2.5 or more, and of all the cellulose acylate resins constituting the dope, the cellulose acylate resin having the largest mass abundance ratio and the cellulose acylate resin having the second largest mass abundance ratio satisfy the following formula (1):

|A−B|×(b/a)≦0.13 (1)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.
[18] The method for producing an optical film of [17], wherein the dope comprises at least three types of cellulose acylate resins differing from each other in the total degree of acyl substitution therein, of all the cellulose acylate resins constituting the dope, the cellulose acylate resin having the largest mass abundance ratio and the cellulose acylate resin having the third largest mass abundance ratio satisfy the following formula (2), and the mass abundance ratio of the cellulose acylate resin having the third largest mass abundance ratio is at least 2.5%:

|A−C|×(c/a)≦0.13 (2)

wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.
[19] The method for producing an optical film of [17] or [18], wherein, of all the cellulose acylate resins constituting the dope, the cellulose acylate resin having the largest mass abundance ratio and all the cellulose acylate resins having a mass abundance ratio of at least 2.5% satisfy the following formula (3):

|A−D|×(d/a)≦0.13 (3)

wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.
[20] The method for producing an optical film of any one of [17] to [19], wherein, of all the cellulose acylate resins constituting the dope, all the cellulose acylate resins having a mass abundance ratio of at least 20% satisfy the following formula (A):

|P−Q|×(q/p)≦0.13 (A)

wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.
[21] The method for producing an optical film of any one of [17] to [20], wherein the dopes comprise at least one dope for outermost layer and at least one dope for core layer, and the dopes are so cast successively or co-cast simultaneously that the dope for outermost layer forms the film outermost layer on the side in contact with the metal support, thereby forming a cellulose acylate laminate film.
[22] The method for producing an optical film of [21], wherein the dopes are so cast successively or co-cast simultaneously that the dope for outermost layer forms the film outermost layer on the side not in contact with the metal support, thereby forming a cellulose acylate laminate film.
[23] The method for producing an optical film of [21] of [22], wherein the dope for core layer comprises at least two types of cellulose acylate resins differing in the total degree of acyl substitution therein, of the cellulose acylate resins constituting the dope for core layer, the cellulose acylate resin having the largest mass abundance ratio and the cellulose acylate resin having the second largest mass abundance ratio satisfy the following formula (4):

|A−B|×(b/a)≦0.10 (4)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.
[24] The method for producing an optical film of any one of [21] to [23], wherein the dope for core layer comprises at least three types of cellulose acylate resins differing from each other in the total degree of acyl substitution therein, of all the cellulose acylate resins constituting the dope for core layer, the cellulose acylate resin having the largest mass abundance ratio and the cellulose acylate resin having the third largest mass abundance ratio satisfy the following formula (5), and the mass abundance ratio of the cellulose acylate resin having the third largest mass abundance ratio is at least 2.5%:

|A−C|×(c/a)≦0.10 (5)

wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.
[25] The method for producing an optical film of any one of [21] to [24], wherein, of all the cellulose acylate resins constituting the dope for core layer, the cellulose acylate resin having the largest mass abundance ratio and all the cellulose acylate resins having a mass abundance ratio of at least 2.5% satisfy the following formula (6):

|A−D|×(d/a)≦0.13 (6)

wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.
[26] The method for producing an optical film of any one of [21] to [25], wherein, of all the cellulose acylate resins constituting the dope for core layer, all the cellulose acylate resins having a mass abundance ratio of at least 20% satisfy the following formula (B):

|P−Q|×(q/p)≦0.13 (B)

wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.
[27] The method for producing an optical film of any one of [17] to [26], wherein any one of the cellulose acylate resin having the largest mass abundance ratio and the cellulose acylate resin having the second largest mass abundance ratio is a cellulose acylate resin having a total degree of acyl substitution of less than 2.5, and the other is a cellulose acylate resin having a total degree of acyl substitution of 2.5 or more.
[28] The method for producing an optical film of any one of [17] to [26], wherein the cellulose acylate resin having the largest mass abundance ratio is a cellulose acylate resin having a total degree of acyl substitution of less than 2.5, and the cellulose acylate resin having the second largest mass abundance ratio is a cellulose acylate resin having a total degree of acyl substitution of 2.5 or more.
[29] The method for producing an optical film of any one of [21] to [28], wherein the mean value Z of the total degree of acyl substitution in the cellulose acylate resins constituting the dope for core layer satisfies the following formula (7):

2.1<Z<2.5. (7)

[30] The method for producing an optical film of any one of [21] to [29], wherein, of the dopes for outermost layer, at least the cellulose acylate resin constituting the dope for outermost layer to form the film outermost layer on the side in contact with the metal support is a cellulose acylate resin having a total degree of acyl substitution of 2.5 or more on average.
[31] The method for producing an optical film of any one of [21] to [30], wherein the dope for outermost layer to form both outermost layers of the film is a cellulose acylate resin having a total degree of acyl substitution of at least 2.5 on average.
[32] The method for producing an optical film of any one of [17] to [31], wherein the dope contains a phosphate compound or a non-phosphate oligomer compound.
[33] The method for producing an optical film of any one of [17] to [32], wherein the cellulose acylate resin is a cellulose acetate.
[34] The method for producing an optical film of any one of [17] to [33], wherein the cellulose acylate resin contains a scrapped material of a cellulose acylate resin-containing film.
[35] The method for producing an optical film of [34], wherein the scrapped material of a cellulose acylate resin-containing film is used as the cellulose acylate resin for the dope for core layer.
[36] The method for producing an optical film of [34] or [35], wherein the scrapped material of a cellulose acylate resin-containing film is a scrapped material of the optical film of any one of [1] to [16].
[37] The method for producing an optical film of any one of [34] to [36], wherein the proportion of the scrapped material of a cellulose acylate resin-containing film to all the cellulose acylate resins in the dope is from more than 10% by mass to 80% by mass.
[38] The method for producing an optical film of any one of [17] to [37], wherein the metal support is SUS.
[39] An optical film produced according to the optical film production method of any one of [17] to [38].
[40] A polarizer comprising an optical film of any one of [1] to [16] and [39].
[41] A liquid crystal display device comprising an optical film of any one of [1] to [16] and [39] or a polarizer of [40].

According to the invention, there is provided an optical film which contains at least a cellulose acylate rein having a total degree of acyl substitution of less than 2.5, which peels well from the metal support in solution casting to form it, which does not whiten and which has good optical expressibility. According to the production method of the invention, the optical film can be produced at a low production cost.

### BRIEF DESCRIPTION OF DRAWINGS

FIG. 1 is a schematic cross-sectional view of one example of the liquid crystal display device of the invention. In FIG. 1, 11 is polarizing element, 12 is polarizing element, 13 is liquid crystal cell, 14 is cellulose acylate film of Examples and Comparative Examples, and 15 is optically anisotropic film (Fujitac TD80UL).

FIG. 2 is an outline view showing one example of producing a three-layered cellulose acylate laminate film by simultaneous co-casting through a co-casting die. In FIG. 2, 1 is dope for outermost layer (surface layer), 2 is dope for core layer, 3 is co-casting Giesser, and 4 is casting support.

### BEST MODE FOR CARRYING OUT THE INVENTION

Description will now be made in detail of the invention. Although the following description of its structural features may often be made on the basis of typical embodiments of the invention, it is to be understood that the invention is not limited to any such embodiment. It is also to be noted that every numerical range as herein expressed by employing the words “from” and “to”, or simply the word “to”, or the symbol “˜” is supposed to include the lower and upper limits thereof as defined by such words or symbol, unless otherwise noted. In the application, “mass %” means equal to “weight %”, and “% by mass” means equal to “% by weight”.

### [Optical Film]

The optical film of the invention (hereinafter this may be referred to as the film of the invention) is an optical film comprising at least two types of cellulose acylate resins differing from each other in the total degree of acyl substitution therein, wherein the cellulose acylate resins include a cellulose acylate resin having a total degree of acyl substitution of less than 2.5 and a cellulose acylate resin having a total degree of acyl substitution of 2.5 or more, and of all the cellulose acylate resins constituting the optical film, the cellulose acylate resin having the largest mass abundance ratio and the cellulose acylate resin having the second largest mass abundance ratio satisfy the following formula (1):

|A−B|×(b/a)≦0.13 (1)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

The film of the invention is described below.

### <Cellulose Acylate Resin>

The cellulose acylate resins for use in the invention include at least a cellulose acylate resin having a total degree of acyl substitution of less than 2.5 and a cellulose acylate resin having a total degree of acyl substitution of 2.5 or more and satisfy the above-mentioned formula (1), and the resins are not specifically defined except for these requirements. The acylate material, cellulose includes cotton linter, wood pulp (hardwood pulp, softwood pulp), etc; and any cellulose acylate from any of such cellulose materials is usable here. As the case may be, two or more of the materials may be mixed for use here. The details of the cellulose materials are described, for example, in Marusawa &Ma's “Lecture of Plastic Materials (17), Cellulose Resins” issued by Nikkan Kogyo Shinbun-sha (1970), or in Hatsumei Kyokai's Disclosure Bulletin No. 2001-1745 (pp. 7-8); and any one described in these is usable here.

### (Cellulose Acylate)

The cellulose acylate preferred for use herein is described in detail. The β-1,4-bonding glucose units constituting cellulose have free hydroxyl groups at the 2-, 3- and 6-positions thereof. Cellulose acylate is a polymer prepared by esterifying a part or all of these hydroxyl groups with an acyl group having 2 or more carbon atoms. The degree of acyl substitution means the ratio of esterification of the hydroxyl group in the 2-, 3- and 6-positions of cellulose (100% esterification provides a degree of substitution of 1).

The total degree of acyl substitution, or that is, DS2+DS3+DS6 is preferably from 2.3 to 2.5, more preferably from 2.35 to 2.5, even more preferably from 2.35 to 2.50. Also preferably, DS6/(DS2+DS3+DS6) is from 0.08 to 0.66, more preferably from 0.15 to 0.60, even more preferably from 0.20 to 0.45. DS2 means the degree of substitution of the 2-positioned hydroxyl group in the glucose unit with an acyl group (hereinafter this may be referred to as “degree of 2-acyl substitution); DS3 means the degree of substitution of the 3-positioned hydroxyl group with an acyl group (hereinafter this may be referred to as “degree of 3-acyl substitution); and DS6 means the degree of substitution of the 6-positioned hydroxyl group with an acyl group (hereinafter this may be referred to as “degree of 6-acyl substitution). DS6/(DS2+DS3+DS6) means the proportion of the degree of 6-acyl substitution to the total degree of acyl substitution, and this may be hereinafter referred to as “proportion of 6-acyl substitution”

Only one type of an acyl group, or two or more different types of acyl groups may be in the film of the invention. The film of the invention preferably has an acyl group having from 2 to 4 carbon atoms as the substituent therein. In case where two or more different types of acyl groups are in the film of the invention, preferably at least one is an acetyl group, and the acyl group having from 2 to 4 carbon atoms is preferably a propionyl group or a butyryl group. The sum total of the degree of substitution of the 2-, 3- and 6-positioned hydroxyl groups with an acetyl group is represented by DSA, and the sum total of the degree of substitution of the 2-, 3- and 6-positioned hydroxyl groups with a propionyl group or a butyryl group is represented by DSB; and the value of DSA+DSB is preferably from 2.3 to 2.6. More preferably, the value of DSA+DSB is from 2.35 to 2.55 and the value of DSB is from 0.10 to 1.70; even more preferably the value of DSA+DSB is from 2.40 to 2.50 and the value of DSB is from 0.5 to 1.2. Controlling the value of DSA and that of DSB to fall within the above range is preferred as providing films of which the fluctuation of Re and Rth is small relative to the environmental humidity.

Specifically, the cellulose acylate resin for use in the invention is preferably a cellulose acylate from the viewpoint of the returnability to nature and of the environmental load.

More preferably, at least 28% of DSB is for the substituent at the 6-positioned hydroxyl group, even more preferably, at least 30% thereof is the substituent at the 6-positioned hydroxyl group, most preferably at least 31% thereof is the substituent at the 6-positioned hydroxyl group, and particularly at least 32% thereof is the substituent at the 6-positioned hydroxyl group. Falling within the range, dopes of higher solubility for films can be prepared, and in particular, good dopes in a chlorine-free solvent can be prepared. Further, dopes having a low viscosity and having good filterability can be prepared.

The acyl group having two or more carbon atoms in the cellulose used in the invention may be an aliphatic group or an aryl group, and are not particularly limited. They may be an alkylcarbonyl ester of cellulose, an alkenylcarbonyl ester of cellulose, an aromatic carbonyl ester of cellulose or an aromatic alkylcarbonyl ester of cellulose. These esters may have a substituent. Preferable examples of the substituents include a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group and a cinnamoyl group. A propionyl group, a butanoyl group, a dodecanoyl group, an octadecanoyl group, a tert-butanoyl group, an oleoyl group, a benzoyl group, a naphthylcarbonyl group and a cinnamoyl group are more preferred, and a propionyl group and a butanoyl group are particularly preferred.

In acylation of cellulose, when an acid anhydride or an acid chloride is used as the acylating agent, the organic solvent as the reaction solvent may be an organic acid, such as acetic acid, or methylene chloride or the like.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a mixed fatty acid ester of cellulose comprises acylating cellulose with a fatty acid corresponding to an acetyl group and other acyl groups (e.g., acetic acid, propionic acid, valeric acid, etc.), or with a mixed organic acid ingredient containing their acid anhydride.

Cellulose acylate for use in the invention may be produced, for example, according to the method described in JP-A 10-45804.

### (Blending of at Least Two Cellulose Acylate Resins)

The film of the invention is an optical film comprising at least two types of cellulose acylate resins differing from each other in the total degree of acyl substitution therein, wherein the cellulose acylate resins include a cellulose acylate resin having a total degree of acyl substitution of less than 2.5 and a cellulose acylate resin having a total degree of acyl substitution of 2.5 or more, and of all the cellulose acylate resins constituting the optical film, the cellulose acylate resin having the largest mass abundance ratio and the cellulose acylate resin having the second largest mass abundance ratio satisfy the following formula (1):

|A−B|×(b/a)≦0.13 (1)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

More preferably, the film of the invention satisfies the following formula (11):

|A−B|×(b/a)≦0.12. (11)

Even more preferably, the film of the invention satisfies the following formula (21):

|A−B|×(b/a)≦0.10. (21)

The film of the invention comprises a combination of a cellulose acylate resin having a total degree of acyl substitution of less than 2.5 and a cellulose acylate resin having a total degree of acyl substitution of 2.5 or more, and therefore its peelability from the metal support in solution casting in forming it is bettered.

The film of the invention satisfies the above-mentioned formula (1), in which the total degree of acyl substitution and the mass ratio of at least two types of the cellulose acylate resins differing in the total degree of acyl substitution therein are specifically defined and the miscibility of the resins with each other is therefore bettered. Accordingly, when a cellulose acylate resin having a total degree of acyl substitution of less than 2.5 and a cellulose acylate resin having a total degree of acyl substitution of 2.5 or more are blended in forming the film of the invention, the film does not whiten.

The cellulose acylate resin having a total degree of acyl substitution of less than 2.5 preferably has a total degree of acyl substitution of from 2.2 to less than 2.5, more preferably from 2.35 to less than 2.5, even more preferably from 2.35 to 2.45.

The cellulose acylate resin having a total degree of acyl substitution of 2.5 or more preferably has a total degree of acyl substitution of from 2.5 to 2.9, more preferably from 2.55 to 2.9, even more preferably from 2.6 to 2.85.

Preferably in the film of the invention, any one of the cellulose acylate resin having the largest mass abundance ratio and the cellulose acylate resin having the second largest mass abundance ratio is a cellulose acylate resin having a total degree of acyl substitution of less than 2.5, and the other is a cellulose acylate resin having a total degree of acyl substitution of 2.5 or more, from the viewpoint of the peelability of the film from a metal support.

More preferably in the film of the invention, the cellulose acylate resin having the largest mass abundance ratio is a cellulose acylate resin having a total degree of acyl substitution of less than 2.5, and the cellulose acylate resin having the second largest mass abundance ratio is a cellulose acylate resin having a total degree of acyl substitution of 2.5 or more.

The mass abundance ratio of each cellulose acylate resin of all the cellulose acylate resins constituting the optical film can be measured according to any known method. As the method for measuring the mass abundance ratio of the cellulose acylate resin, for example, employable herein is a method of measuring the peak area according to the HPLC-CAD method to be mentioned below; however, the method should not be limited to the HPLC-CAD method.

In the HPLC-CAD method, the mass abundance ratio of a cellulose acylate resin is in proportional relation to the value of the area (peak area); and therefore, according to the method, the mass abundance ratio of the cellulose acylate resin constituting the film of the invention can be measured and determined.

In the invention, from the viewpoint of the accuracy in measuring the distribution of the total degree of acyl substitution, the total degree of acyl substitution and the mass abundance ratio of each cellulose acylate resin are measured according to the HPLC-CAD method to be mentioned below.

Preferably, the film of the invention comprises at least three types of cellulose acylate resins differing from each other in the total degree of acyl substitution therein, wherein, of all the cellulose acylate resins constituting the optical film, the cellulose acylate resin having the largest mass abundance ratio and the cellulose acylate resin having the third largest mass abundance ratio satisfy the following formula (2), and the mass abundance ratio of the cellulose acylate resin having the third largest mass abundance ratio is at least 2.5%;

|A−C|×(c/a)≦0.13 (2)

wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.

More preferably, the film of the invention satisfies the following formula (12):

|A−C|×(c/a)≦0.12. (12)

Even more preferably, the film of the invention satisfies the following formula (22):

|A−C|×(c/a)≦0.11. (22)

Preferably, of all the cellulose acylate resins constituting the optical film of the invention, the cellulose acylate resin having the largest mass abundance ratio and all the cellulose acylate resins having a mass abundance ratio of at least 2.5% satisfy the following formula (3):

|A−D|×(d/a)≦0.13 (3)

wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.

More preferably, the film of the invention satisfies the following formula (13):

|A−D|×(d/a)≦0.12. (13)

Even more preferably, the film of the invention satisfies the following formula (23):

|A−D|×(d/a)≦0.11. (23)

Preferably, of all the cellulose acylate resins constituting the optical film of the invention, all the cellulose acylate resins having a mass abundance ratio of at least 20% satisfy the following formula (A):

|P−Q|×(q/p)≦0.13 (A)

wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.

More preferably, the film of the invention satisfies the following formula (1A):

|P−Q|×(q/p)≦0.12. (1A)

Even more preferably, the film of the invention satisfies the following formula (2A):

|P−Q|×(q/p)≦0.11. (2A)

In case where the film of the invention comprises at least four types of cellulose acylate resins differing from each other in the total degree of acyl substitution therein, preferably, any two types of the cellulose acylate resins having a mass abundance ratio of at least 2.5% of all the cellulose acylate resins therein satisfy:

|difference in the substitution degree between the two types of cellulose acylate resins|×(quotient of the mass abundance ratio between the two types of cellulose acylate resins)≦0.13.

In this, for the quotient of the mass abundance ratio between the two types of cellulose acylate resins, the mass abundance ratio of the cellulose acylate resin having a larger mass abundance ratio is the dominator.

In this case, more preferably, the film of the invention satisfies:

|difference in the substitution degree between the two types of cellulose acylate resins|×(quotient of the mass abundance ratio between the two types of cellulose acylate resins)≦0.1.

Even more preferably, the film satisfies:

|difference in the substitution degree between the two types of cellulose acylate resins|×(quotient of the mass abundance ratio between the two types of cellulose acylate resins)≦0.08.

In the invention, the cellulose acylate resin having a mass abundance ratio of less than 2.5% relative to all cellulose acylates does not have any significant influence on the resin miscibility and the film whitening, and is therefore taken as a noise. Accordingly, it is desirable that the resin of the type is not taken into consideration in the computation in the formulae (1) to (6).

Preferably in the film of the invention, the film center part separated from both surfaces of the film by at least 20% in the film thickness direction comprises at least two types of cellulose acylate resins differing from the total degree of acyl substitution therein, and of the cellulose acylate resins constituting the film center part, the cellulose acylate resin having the largest mass abundance ratio and the cellulose acylate resin having the second largest mass abundance ratio satisfy the following formula (4):

|A−B|×(b/a)≦0.10 (4)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

More preferably in the film of the invention, the cellulose acylate resins constituting the film center part satisfy the following formula (14):

|A−B|×(b/a)≦0.08. (14)

Even more preferably in the film of the invention, the cellulose acylate resins constituting the film center part satisfy the following formula (24):

|A−B|×(b/a)≦0.06. (24)

In the film of the invention, preferably, the film center part comprises at least three types of cellulose acylate resins differing from each other in the total degree of acyl substitution therein, of all the cellulose acylate resins constituting the film center part, the cellulose acylate resin having the largest mass abundance ratio and the cellulose acylate resin having the third largest mass abundance ratio satisfy the following formula (5), and the mass abundance ratio of the cellulose acylate resin having the third largest mass abundance ratio is at least 2.5%:

|A−C|×(c/a)≦0.10 (5)

wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.

In the film of the invention, more preferably, the cellulose acylate resins constituting the film center part satisfy the following formula (15):

|A−C|×(c/a)≦0.08.

In the film of the invention, even more preferably, the cellulose acylate resins constituting the film center part satisfy the following formula (25):

|A−C|×(c/a)≦0.07. (25)

Preferably, of all the cellulose acylate resins constituting the film center part in the film of the invention, the cellulose acylate resin having the largest mass abundance ratio and all the cellulose acylate resins having a mass abundance ratio of at least 2.5% satisfy the following formula (6):

|A−D|×(d/a)≦0.13 (6)

wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.

More preferably, the film of the invention satisfies the following formula (16):

|A−D|×(d/a)≦0.12. (16)

Even more preferably, the film of the invention satisfies the following formula (26):

|A−D|×(d/a)≦0.11. (26)

Preferably, of all the cellulose acylate resins constituting the film center part in the film of the invention, all the cellulose acylate resins having a mass abundance ratio of at least 20% satisfy the following formula (B):

|P−Q|×(q/p)≦0.13 (B)

wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.

More preferably, the film of the invention satisfies the following formula (1B):

|P−Q|×(q/p)≦0.12. (1B)

Even more preferably, the film of the invention satisfies the following formula (2B):

|P−Q|×(q/p)≦0.11. (2B)

### (HPLC-CAD Method)

The HPLC-CAD method is a method where high-performance liquid chromatography (HPLC) and a corona charged aerosol detector are combined and where the peaks of the total degree of acyl substitution of the cellulose acylate resins that differ from each other in the total degree of acyl substitution in a cellulose acylate film sample to be analyzed are detected and the peak areas are computed. According to the method, not only a cellulose acylate dope but also a cellulose acylate film itself can be analyzed for the constitutive ingredients. Accordingly, when a scrapped material of a cellulose acylate resin-containing film is used as a starting material, the total degree of acyl substitution of the cellulose acylate resins constituting the film material and the mass abundance ratio thereof can be determined according to the method.

The chart of at least two types of cellulose acylate film samples that differ in the total degree of acyl substitution therein as analyzed according to the HPLC-CAD method gives two or more peaks. In the chart, the horizontal axis indicates the total degree of acyl substitution, and the vertical axis indicates the charge level of the cellulose acylate resin having the corresponding total degree of acyl substitution; and the peak area of each peak can be computed.

In the invention, for the cellulose acylate resin identified by a given peak, the value of the total degree of acyl substitution indicated by the maximum value on the vertical axis is considered to correspond to the total degree of acyl substitution of the cellulose acylate resin. Similarly, the peak area of a peak relative to the total peak area of all the peaks is considered to correspond to the mass abundance ratio of the cellulose acylate resin that gives the peak.

In case where a plurality of peaks partly overlap with each other, an approximate curve is formed from the individual peak areas on the assumption that the respective peak areas could be approximated to the regular Gaussian distribution, and this is divided to compute the peak area of each peak.

In the invention, the apparatus for use for the HPLC-CAD method is not specifically defined, and any apparatus is employable herein in which the total degree of acyl substitution and the mass abundance ratio of a cellulose acylate resin can be detected.

For example, as HPLC, usable is Shimadzu's Model LC-2010HT.

As CAD, for example, usable is Corona's Model CAD™ HPLC Detector.

Preferred conditions of solvent, reversed phase/normal phase partition mode, column, flow rate and others in HPLC in the invention are mentioned below.

Linear gradient detector with solvent from CHCl₃/MeOH (90/10 (v/v)):MeOH.H₂O (8/1 (v/v))-20/80 to CHCl₃.MeOH (9/1) for 30 min. Normal phase partition mode.

### Column: Novapak Phenyl (Waters), 3.90×150 mm.

Flow rate: 1.0 ml/min.

In the invention, preferred conditions for detection in CAD are, for example, as follows:

Column temperature: 30° C.
Sample concentration: 0.002% by mass.
Sample amount: 50 μL.

In the invention, the form of the cellulose acylate resin applicable to the HPLC-CAD method includes a dope of a cellulose acylate resin dissolved in an organic solvent, and a scrapped material of a once-formed cellulose acylate resin-containing film. The scrapped material includes chips prepared by crushing a once-formed cellulose acylate resin-containing film, a solution prepared by dissolving a once-formed cellulose acylate resin-containing film in an organic solvent, etc. In recent years, liquid crystal display devices become larger and there rises the problem of loss of panels caused by failure of sticking of a polarizing plate and a panel. This is called reworkability of a polarizer. This problem is solved by imparting an excellent peelability from the panel to the polarizer even when the failure of sticking occurs. It is therefore strongly desired to impart the reworkability to polarizers, particularly those for a large liquid crystal display device. However, there is still a problem that an optical compensatory film of the optically compensatory sheet remains on the surface of a glass substrate at least once in a repeated reworking. It is preferable in the invention that the film of the invention is produced by a scrapped material of cellulose acylate resin that was in the form of film and thereby reworkability in the recycle is largely improved. The term “reworkability” in this application means peelability of a cellulose acylate film (or a polarizer having a cellulose acylate film) from the glass substrate of a liquid crystal cell for the purpose of reuse and others.

Preferably, the scrapped material is pretreated to be formed into a solution thereof dissolved in an organic solvent before put into a HPLC column. The method for producing the scrapped material of a cellulose acylate resin-containing film is described below.

Preferred conditions for the pretreatment are mentioned below.

An organic solvent CHCl₃/MeOH (90/10 (v/v)):MeOH.H₂O (8/1 (v/v))=20/80 is prepared, and a film to be analyzed is dissolved therein to have a concentration of 0.002% by mass.

Next, a solution of CHCl₃.MeOH (9/1) is prepared, and the film is dissolved to have a concentration of 0.002% by mass.

In the invention, the sample of the film to be analyzed for the film center part thereof as separated by at least 20% from both surfaces of the film in the film thickness direction, portion of the center part 60% in the film thickness direction according to the HPLC-CAD method, is prepared according to the method mentioned below.

First, the thickness of the film in the film section direction is measured with an optical microscope.

The film surface is cut off with a cutter knife, and the cross section of the resulting film is again observed with an optical microscope. In this, the film is confirmed that its surface has been cut off to the inside by more than 20% from the initial surface thereof.

Next again, the back of the film is cut off similarly with a cutter knife, and the cross section of the film is again observed with an optical microscope. In this, the film is confirmed that its back has been cut off to the inside by more than 20% from the initial back thereof.

### (Layer Constitution of Cellulose Acylate Film)

The film of the invention may be composed of one layer or two or more layers. The cellulose acylate constituting each layer may have a uniform degree of acyl substitution, or two or more cellulose acylates may be mixed to constitute one layer. In case where the film of the invention is composed of one layer, the two or more cellulose acylates must be in the form of a blend thereof. In this case, accordingly, the film of the invention contains, in one layer thereof, at least two types of cellulose acylate resins differing in the total degree of acyl substitution therein, and the cellulose acylate resins include at least a cellulose acylate resin having a total degree of acyl substitution of less than 2.5 and a cellulose acylate resin having a total degree of acyl substitution of 2.5 or more.

On the other hand, in case where the film of the invention is composed of two or more layers, the cellulose acylate constituting each other may have a uniform degree of acyl substitution, or two or more cellulose acylates may be in one layer as mixed. Preferably, at least one outermost layer of the film contains a cellulose acylate resin having a total degree of acyl substitution of at least 2.5, from the viewpoint of enhancing the peelability of the film from a metal support in solution casting in its formation.

More preferably, at least one outermost layer of the film contains a cellulose acylate resin having a total degree of acyl substitution of from 2.6 to 2.9, even more preferably contains a cellulose acylate resin having a total degree of acyl substitution of from 2.65 to 2.85. In case where the film of the invention is composed of two or more layers, even more preferably, the mean value Z of the total degree of acyl substitution in the cellulose acylate resin constituting the layer having the largest thickness (hereinafter this may be referred to as a core layer) satisfies the following formula (7):

2.1<Z<2.5. (7)

The method for computing the mean value of the total degree of acyl substitution in the cellulose acylate resin constituting one layer means the sum total of the product of the total degree of acyl substitution of each cellulose acylate resin and the proportion of the mass abundance ratio relative to all the cellulose acylate resins constituting the layer.

The mean value Z of the total degree of acyl substitution in the cellulose acylate resin constituting the core layer is more preferably from 2.2 to 2.5, even more preferably from 2.3 to 2.48.

In case where the film of the invention is composed of two or more layers, preferably, the core layer satisfies the above-mentioned formula (4), more preferably, the formula (5), the formula (6) and the formula (B), from the viewpoint of using the scrapped material to be mentioned below and reducing the production cost.

In case where the film of the invention is composed of two or more layers, preferably, no adhesive or agglutinant exists between the layers from the viewpoint of simplifying the production process; and the optical film having the layer constitution of the type can be produced according to a lamination casting method to be mentioned below.

The adhesive and the agglutinant to be used in producing a multilayer film in which the constitutive layers are bonded to each other via an adhesive or an agglutinant are described, for example, in JP-A 11-295527.

An embodiment having a laminate structure of three or more layers is also preferred for the film of the invention from the viewpoint of increasing the latitude in the process of realizing the desired optical properties in the film serving as an optical compensatory film.

Preferably, the film of the invention is composed of three or more layers, in which both outermost layers of the film each are a cellulose acylate layer having a total degree of acyl substitution of at least 2.5 on average. In case where the film of the invention has a three-layered structure, preferably, both surface layers thereof comprise the same cellulose acylate having the same degree of acyl substitution therein from the viewpoint of the production cost, the dimensional stability and the resistance to curling with environmental moisture/heat change.

In the case where the film of the invention has a laminate structure of three or more layers, the surface layer of the film not in contact with the metal support in film formation is referred to as a skin A layer.

Preferably, the film of the invention has a three-layered structure of skin B layer/core layer/skin A layer.

### (Film Thickness)

The thickness of the optical film of the invention may be suitably defined depending on, for example, the type of the polarizer for which the film is used, but is preferably from 30 to 60 μm, more preferably from 35 to 55 μM. When the film thickness is at most 60 μm, then it is favorable as the production cost may be reduced.

In case where the film of the invention is composed of two or more layers, the thickness of each layer therein is preferably such that the ratio of the thickness of the outermost layer to the total thickness of the film (thickness of the outermost layer+thickness of the core layer) is from 0.005 to 0.20, more preferably from 0.005 to 0.15, even more preferably from 0.01 to 0.10.

In case where the film of the invention is composed of three or more layers, the total thickness of both outermost layers thereof is preferably from 30 to 120 more preferably from 35 to 100 μm, even more preferably from 40 to 80 μm.

### <Additive>

Additives may be added to the film of the invention. The additives include non-phosphate compounds, retardation regulators (retardation enhancers, retardation reducers), plasticizers such as phthalates or phosphates, UV absorbents, antioxidants, mat agents, etc.

Of those, the film of the invention preferably contains a phosphate compound or a non-phosphate polyester compound from the viewpoint of the wet heat durability thereof, especially from the viewpoint of preventing additive bleeding from the film. The additives that may be added to the film of the invention are described in detail below.

### (Non-Phosphate Compound)

The film of the invention preferably contains a non-phosphate compound in the low-substitution layer. The non-phosphate compound in the layer exhibits an effect of preventing whitening.

In this description, the “non-phosphate compound” means “a compound having an ester bond in which the acid contributing to the ester bond is one except phosphoric acid”. In other words, the “non-phosphate compound” means an ester compound not containing phosphoric acid.

The non-phosphate compound may be a low-molecular compound or a polymer (high-molecular compound). The non-phosphate compound in the form of a polymer may be hereinafter referred to as a non-phosphate polymer.

As the non-phosphate compound, widely usable are high-molecular additives and low-molecular additives known as additives to cellulose acylate films. Preferably, the amount of the additive is from 1 to 35% by mass of the cellulose resin, more preferably from 4 to 30% by mass, even more preferably from 10 to 25% by mass.

The high-molecular additive for use as the non-phosphate compound in the film of the invention has a recurring unit in the compound, and its number-average molecular weight is preferably from 700 to 10000. The high-molecular additive has a function of increasing the evaporation speed of solvent in a solution casting method, and a function of reducing the residual solvent amount. In addition, the additive exhibits various useful effects from the viewpoint of improving the film quality of, for example, improving the mechanical property thereof, imparting flexibility to the film, imparting absorption resistance thereto and reducing the water permeation through the film.

The number-average molecular weight of the high-molecular additive of non-phosphate compound for use in the invention is more preferably from 700 to 8000, even more preferably from 700 to 5000, still more preferably from 1000 to 5000.

The high-molecular additive of non-phosphate compound for use in the invention is described in detail below with reference to specific examples thereof given below; however, needless-to-say, the high-molecular additive of non-phosphate compound for use in the invention is not limited to these.

The polymer additive of non-phosphate compound includes polyester polymer (aliphatic polyester polymer, aromatic polyester polymer, etc.), and copolymer of polyester ingredient and other ingredient, etc. Preferred are aliphatic polyester polymer, aromatic polyester polymer; copolymer of polyester polymer (aliphatic polyester polymer, aromatic polyester polymer, etc.) and acrylic polymer; and copolymer of polyester polymer (aliphatic polyester polymer, aromatic polyester polymer, etc.) and styrenic polymer. More preferred are polyester compounds containing an aromatic ring as at least one copolymerization ingredient.

The aliphatic polyester-type polymers for use in the invention is one produced by reaction of a mixture of an aliphatic dicarboxylic acid having from 2 to 20 carbon atoms, and a diol selected from the group consisting of aliphatic dials having from 2 to 12 carbon atoms and alkyl ether dials having from 4 to 20 carbon atoms, and both ends of the reaction product may be as such, or may be blocked by further reaction with a monocarboxylic acid or a monoalcohol. The terminal blocking may be effected for the reason that the absence of a free carboxylic acid in the plasticizer is effective for the storability of the plasticizer. The dicarboxylic acid for the polyester plasticizer for use in the invention is preferably an aliphatic dicarboxylic acid having from 4 to 20 carbon atoms or an aromatic dicarboxylic acid having from 8 to 20 carbon atoms.

The aliphatic dicarboxylic acids having from 2 to 20 carbon atoms preferably for use in the film of the invention include, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

More preferred aliphatic dicarboxylic acids in these are malonic acid, succinic acid, maleic acid, fumaric acid, glutaric acid, adipic acid, azelaic acid, 1,4-cyclohexanedicarboxylic acid. Particularly preferred dicarboxylic acids are succinic acid, glutaric acid and adipic acid.

The diol used for the high-molecular additive are selected, for example, from aliphatic diols having from 2 to 20 carbon atoms, alkyl ether dials having from 4 to 20 carbon atoms.

Examples of the aliphatic dial having from 2 to 20 carbon atoms include an alkyldiol and an aliphatic diol. For example, an ethandiol, 1,2-propandiol, 1,3-propandiol, 1,2-butandiol, 1,3-butandiol, 2-methyl-1,3-propandiol, 1,4-butandiol, 1,5-pentandiol, 2,2-dimethyl-1,3-propandiol (neopentyl glycol), 2,2-diethyl-1,3-propandiol (3,3-dimethylolpentane), 2-n-buthyl-2-ethyl-1,3-propandiol (3,3-dimethyloiheptane), 3-methyl-1,5-pentandiol, 1,6-hexandiol, 2,2,4-trimethyl-1,3-pentandiol, 2-ethyl-1,3-hexandiol, 2-methyl-1,8-octandiol, 1,9-nonandiol, 1,10-decandiol, 1,12-octadecandiol, etc. One or more of these glycols may be used either singly or as combined mixture.

Specific examples of preferred aliphatic dials include an ethandiol, 1,2-propandiol, 1,3-propandiol, 1,2-butandiol, 1,3-butandiol, 2-methyl-1,3-propandiol, 1,4-butandiol, 1,5-pentandiol, 3-methyl-1,5-pentandiol, 1,6-hexandiol, 1,4-cyclohexandiol, 1,4-cyclohexandimethanol. Particularly preferred examples include ethandiol, 1,2-propandiol, 1,3-propandiol, 1,2-butandiol, 1,3-butandiol, 1,4-butandiol, 1,5-pentandiol, 1,6-hexandiol, 1,4-cyclohexandiol, 1,4-cyclohexanedimethanol.

Specific examples of preferred alkyl ether dials having from 4 to 20 carbon atoms are polytetramethylene ether glycol, polyethylene ether glycol and polypropylene ether glycol, and combinations of these. The average degree of polymerization is not limited in particular, and it is preferably from 2 to 20, more preferably 2 to 10, further preferbly from 2 to 5, especially preferably from 2 to 4. As these examples, Carbowax resin, Pluronics resin and Niax resin are commercially available as typically useful polyether glycols.

In the invention, especially preferred is a high-molecular additive of which the terminal is blocked with an alkyl group or an aromatic group. The terminal protection with a hydrophobic functional group is effective against aging at high temperature and high humidity, by which the hydrolysis of the ester group is retarded.

Preferably, the polyester plasticizer in the invention is protected with a monoalcohol residue or a monocarboxylic acid residue in order that both ends of the polyester plasticizer are not a carboxylic acid or a hydroxyl group.

In this case, the monoalcohol residue is preferably a substituted or unsubstituted monoalcohol residue having from 1 to 30 carbon atoms, including, for example, aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tent-nonyl alcohol, decanol, dodecanol, dodecahexanol, dodecaoctanol, allyl alcohol, oleyl alcohol; and substituted alcohols such as benzyl alcohol, 3-phenylpropanol.

Alcohol residues for terminal blocking that are preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol, more preferably methanol, ethanol, propanol, isobutanol, cyclohexyl alcohol, 2-ethylhexyl alcohol, isononyl alcohol, benzyl alcohol.

In blocking with a monocarboxylic acid residue, the monocarboxylic acid for use as the monocarboxylic acid residue is preferably a substituted or unsubstituted monocarboxylic acid having from 1 to 30 carbon atoms. It may be an aliphatic monocarboxylic acid or an aromatic monocarboxylic acid. Preferred aliphatic monocarboxylic acids are described. They include acetic acid, propionic acid, butanoic acid, caprylic acid, caproic acid, decanoic acid, dodecanoic acid, stearic acid, oleic acid. Preferred aromatic monocarboxylic acids are, for example, benzoic acid, p-tert-butylbenzoic acid, orthotoluic acid, metatoluic acid, paratoluic acid, dimethylbenzoic acid, ethylbenzoic acid, normal-propylbenzoic acid, aminobenzaic acid, acetoxybenzoic acid. One or more of these may be used either singly or as combined.

The high-molecular additive for use in the invention may be easily produced according to any of a thermal melt condensation method of polyesterification or interesterification of the above-mentioned dicarboxylic acid and diol and/or monocarboxylic acid or monoalcohol for terminal blocking, or according to an interfacial condensation method of an acid chloride of those acids and a glycol in an ordinary manner. The polyester additives are described in detail in Koichi Murai's “Additives, Their Theory and Application” (by Miyuki Publishing, first original edition published on Mar. 1, 1973). The materials described in JP-A 05-155809, 05-155810, 05-197073, 2006-259494, 07-330670, 2006-342227, 2007-003679 are also usable herein.

The aromatic polyester polymers are obtained by copolymerizing the above-mentioned polyester polymers with a monomer having an aromatic ring. The monomer having an aromatic ring is at least one monomer selected from aromatic dicarboxylic acids having from 8 to 20 carbon atoms, and aromatic dials having from 6 to 20 carbon atoms.

The aromatic dicarboxylic acids for use in the film of the invention having from 8 to 20 carbon atoms include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid and 2,6-naphthalene dicarboxylic acid etc. Preferable aromatic dicarboxylic acids are phthalic acid, terephthalic acid and isophthalic acid.

The aromatic dials having from 6 to 20 carbon atoms, not limited, include Bisphenol A, 1,2-hydroxybenzene, 1,3-hydroxybenzene, 1,4-hydroxybenzene, 1,4-dimethylolbenzene, and preferably include bisphenol A, 1,4-hydroxybenzene and 1,4-dimethylolbenzene.

In the invention, the aromatic polyester polyester is combined with at least one of aromatic dicarboxylic acids or aromatic dials, and the combination is not specifically defined. Different types of the respective ingredients may be combined with no problem. In the invention, especially preferred are high-molecular-weight additives the terminal of which is blocked with an alkyl group or an aromatic group, as so mentioned in the above; and for the blocking, the above-mentioned method may be employed.

For example, phosphate compounds and non-ester additives known as additives to cellulose acylate film can be widely used in the invention as a retardation reducer other than non-phosphate compounds.

The polymer-type retardation reducer may be selected from phosphate polyester polymers, styrenic polymers, acrylic polymers and their copolymers; and acrylic polymers and styrenic polymers are preferred. Preferably, the retardation reducer contains at least one polymer having a negative intrinsic birefringence such as styrenic polymer and acrylic polymer.

The low-molecular weight retardation reducer except non-phosphate compounds includes the following. These may be solid or oily. In other words, they are not specifically defined in point of the melting point or boiling point thereof. For example, there is mentioned mixing UV-absorbent materials having a melting point of 20° C. or less, or having a melting point of 20° C. or more, as well as mixing antiaging agents similarly. IR absorbent dyes are described in, for example, JP-A 2001-194522. The additive may be added in any stage of preparing the cellulose acylate solution (dope); and the additive may be added at the end of the dope preparation process in the final step for additive addition of the process. The amount of the material is not specifically defined so far as the material could exhibit its function.

The low-molecular retardation reducer of compounds except non-phosphate compounds is not specifically defined. For example, the compounds are described in detail in JP-A 2007-272177, paragraphs [0066] to [0085].

The compounds represented by a general formula (1) in JP-A 2007-272177, paragraphs [0066] to [0085] may be produced according to the following method.

The compounds of formula (1) in the patent publication can be produced by condensation of a sulfonyl chloride derivative and an amine derivative.

The compounds of a general formula (2) in JP-A 2007-272177 can be produced by dehydrating condensation of a carboxylic acid and an amine with a condensing agent (e.g., dicyclohexylcarbodiimide (DCC), etc.), or by substitution reaction between a carboxylic acid chloride derivative and an amine derivative.

The retardation reducer in the invention is preferably an Rth reducer from the viewpoint of realizing a favorable Nz factor. Of the retardation reducers, the Rth reducer includes, for example, acrylic polymers, styrenic polymers, and low-molecular-weight compounds of formulae (3) to (7) of JP-A 2007-272177. Of those, preferred are acrylic polymers and styrenic polymers; and more preferred are acrylic polymers.

The retardation reducing agent is added in an amount of preferably from 0.01 to 30% by mass of the cellulose resin, more preferably from 0.1 to 20% by mass of the cellulose resin, still more preferably from 0.1 to 10% by mass of the cellulose resin.

When the retardation reducing agent is added in an amount of at most 30% by mass, compatibility with the cellulose resin can be improved and whitening can be inhibited. When two or more retardation reducing agents are used, the sum amount of the agents is preferably within the above range.

### (Plasticizer)

Many compounds known for a plasticizer of a cellulose acylate may be preferably used as a plasticizer in the invention. As the plasticizer, usable are phosphates or carboxylates. Examples of the phosphates include triphenyl phosphate (TPP) and tricresyl phosphate (TCP). The carboxylates are typically phthalates and citrates. Examples of the phthalate compounds include dimethyl phthalate (DMP), diethyl phthalate (DEP), dibutyl phthalate (DEP), dioctyl phthalate (DOP), diphenyl phthalate (DPP) and diethylhexyl phthalate (DEHP). Examples of the citrates include triethyl O-acetylcitrate (OACTE) and tributyl O-acetylcitrate (OACTB). Examples of other carboxylates include butyl oleate, methylacetyl ricinoleate, dibutyl sebacate, and various trimellitates. Preferred for use herein are phthalate plasticizers (DMP, DEP, DBP, DOP, DPP, DEHP). More preferred are DEP and DPP.

### (Retardation Enhancer)

The film of the invention may contain a retardation enhancer. Containing a retardation enhancer, the film may express high Re expressibility at a low draw ratio in stretching it. The type of the retardation enhancer for use herein is not specifically defined. There may be mentioned retardation-enhancing, rod-shaped or discotic compounds and non-phosphate compounds. Of such rod-shaped or discotic compounds, those having at least two aromatic rings are preferred for the retardation enhancer for use herein.

Two or more different types of retardation enhancers may be combined for use herein.

Preferably, the retardation enhancer has a maximum absorption in a wavelength region of from 250 to 400 nm, and does not substantially have an absorption in a visible light region.

As the retardation enhancer, for example, the compounds described in JP-A 2004-50516 and 2007-86748 are usable here, to which, however, the invention should not be limited.

As the discotic compound, for example, preferred for use herein are the compounds described in EP 0911656A2, the triazine compounds described in JP-A 2003-344655, the triphenylene compounds described in JP-A 2008-150592, paragraphs [0097] to [0108].

The discotic compounds may be produced according to known methods, for example, according to the method described in JP-A 2003-344655 or the method described in JP-A 2005-134884.

Apart from the above-mentioned discotic compounds, rod-shaped compounds having a linear molecular structure are also preferably used here, and for example, the rod-shaped compounds described in JP-A 2008-150592, paragraphs [0110] to [0127] are preferred for use here.

Two or more different types of rod-shaped compounds may be combined for use herein, of which the maximum absorption wavelength (λmax) thereof is longer than 250 nm in the UV absorption spectrum of the solution of the compound.

The rod-shaped compounds may be produced with reference to the methods described in literature. The literature includes Mal. Cryst. Liq. Cryst., Vol. 53, p. 229 (1979); ibid., Vol. 89, p. 93 (1982); ibid., Vol. 145, p. 111 (1987); ibid., Vol. 170, p. 43 (1989); J. Am. Chem. Soc., Vol. 113, p. 1349 (1991); ibid., Vol. 118, p. 5346 (1996); ibid., Vol. 92, p. 1582 (1970); J. Org. Chem., Vol. 40, p. 420 (1975); Tetrahedron, Vol. 48, No. 16, p. 3437 (1992).

### (Carbohydrate Derivative)

The film of the invention may contain a carbohydrate derivative. When a carbohydrate derivative is added to a cellulose acylate, the water content of the film can be greatly reduced not detracting from the expressibility of the optical properties thereof and not increasing the haze thereof.

Further, when the cellulose acylate film is used as a protective film for polarizer, the polarizer may be significantly protected from degradation in high-temperature/high-humidity condition.

Preferably, the carbohydrate derivatives for use in the invention have, including the substituents therein, a structure represented by the following general formula (1):

(OH)ₚ-G-(L¹-R¹)_{q}(L²-R²)ᵣ (1)

In formula (1), C represents a monose residue, or a polyose residue; L¹ and L² each independently represent anyone of —O—, —CO— and —NR³—; R¹, R² and R³ each independently represent a hydrogen atom or a monovalent substituent; at least one of R¹ and R² preferably has an aromatic ring. p, q and r each independently represent an integer of 0 or more; at least one of q and r is an integer of 1 or more; (p+q+r) is equal to the number of the hydroxyl groups on the assumption that G is an unsubstituted sugar group having a cyclic acetal structure.

The preferred range of G is the same as the preferred range of the constituent sugar to be mentioned below.

Preferably, L¹ and L² each are —O— or —CO—, more preferably —O—. When L¹ and L² are —O—, they are more preferably an ether bond-derived or ester bond-derived linking group, even more preferably an ester bond-derived linking group.

In case where the compound has two or more L¹'s and L²'s, then they may be the same or different.

Preferably, R, R² and R³ each are a monovalent substituent. More preferably, when L¹ and L² are —O— (or that is, when R¹, R² and R³ are substituted for the hydroxyl group in the carbohydrate derivative), preferably, R¹, R² and R³ are selected from a substituted or unsubstituted acyl group, a substituted or unsubstituted aryl group, a substituted or unsubstituted alkyl group, or a substituted or unsubstituted amino group, more preferably they are a substituted or unsubstituted acyl group, a substituted or unsubstituted alkyl group, or a substituted or unsubstituted aryl group, even more preferably an unsubstituted acyl group, a substituted or unsubstituted alkyl group, or an unsubstituted aryl group.

In case where the compound has two or more R¹'s, R²'s and R³'s, then they may be the same or different.

p indicates an integer of 0 or more, and is preferred range is the same as the preferred range of the number of the hydroxyl groups per monose unit to be mentioned below.

q and r each independently indicate an integer of 0 or more, and at least one of them is an integer of 1 or more.

Preferably, one of q and r is 0.

(p+q+r) is equal to the number of the hydroxyl groups on the assumption that G is an unsubstituted sugar group having a cyclic acetal structure. Accordingly, the uppermost limit of p, q and r is primarily determined in accordance with the structure of G.

Preferred examples of the substituents in the carbohydrate derivative include an alkyl group (preferably an alkyl group having from 1 to 22 carbon atoms, more preferably from 1 to 12 carbon atoms, even more preferably from 1 to 8 carbon atoms, for example, a methyl group, an ethyl group, a propyl group, a hydroxyethyl group, a hydroxypropyl group, a 2-cyanoethyl group, a benzyl group), an aryl group (preferably an aryl group having from 6 to 24 carbon atoms, more preferably from 6 to 18 carbon atoms, even more preferably from 6 to 12 carbon atoms, for example, a phenyl group, a naphthyl group), an acyl group (preferably an acryl group having from 1 to 22 carbon atoms, more preferably from 2 to 12 carbon atoms, even more preferably from 2 to 8 carbon atoms, for example, an acetyl group, a propionyl group, a butyryl group, a pentanoyl group, a hexanoyl group, an octanoyl group, a benzoyl group, a toluoyl group, a phthaloyl group), an amide group (preferably an amide group having from 1 to 22 carbon atoms, more preferably from 2 to 12 carbon atoms, even more preferably from 2 to 8 carbon atoms, for example, a formamide group, an acetamide group), an imide group (preferably an imide group having from 4 to 22 carbon atoms, more preferably from 4 to 12 carbon atoms, even more preferably from 4 to 8 carbon atoms, for example, a succinimide group, a phthalimide group).

Of those, the substituent having at least one aromatic ring includes a carbohydrate derivative that contains a substituent having an aromatic ring not conjugated with a functional group having a double bond (e.g., carbonyl group). Preferred examples of the substituent having an aromatic group not conjugated with a functional group having a double bond include a benzyl group, a phenylacetyl group, etc.

On the other hand, preferred examples of the substituent having an aromatic ring conjugated with a functional group having a double bond include, for example, a benzoyl group.

Preferably, the carbohydrate derivative for use herein is a carbohydrate derivative that contains a substituent having an aromatic ring conjugated with a functional group having a double bond from the viewpoint that the maximum value of the molar extinction coefficient at a wavelength of from 230 nm to 700 nm could be at most 30×10³, more preferably a carbohydrate derivative substituted with a benzoyl group.

### —Number of Hydroxyl Groups Per Monose Unit—

The number of the hydroxyl groups per monose unit (hereinafter this may be referred to as a hydroxyl group content) in the carbohydrate derivative for use in the invention is preferably at most 1. When the hydroxyl group content is controlled to fall within the above range, it is favorable since the carbohydrate derivative may be prevented from moving into the polarizing element layer and from breaking the PVA-iodine complex in high-temperature/high-humidity condition and since the polarizing element may be protected from degradation in high-temperature/high-humidity condition.

### —Constituent Sugar—

The carbohydrate derivative for use in the invention is preferably a derivative of a carbohydrate that contains a monose or from 2 to 5 monose units, more preferably a derivative of a carbohydrate that contains a monose or two monose units.

In the monose or polyose that preferably constitutes the carbohydrate derivative, the substitutable groups in the molecule (for example, hydroxyl group, carboxyl group, amino group, mercapto group) are substituted with at least two types of substituents, and at least one of the substituents is substituted with a substituent having at least one aromatic ring.

Examples of the carbohydrates containing a monose or from 2 to 10 monose units include, for example, erythrose, threose, ribose, arabinose, xylose, lyxose, arose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbeliferose, lycotetraose, maltotetraose, stachyose, baltopentaose, belbalpentaose, maltohexaose, α-cyclodextrin, β-cyclodextrin, γ-cyclodextrin, δ-cyclodextrin, xylitol, sorbitol, etc.

Preferred are ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol, sorbitol; more preferred are arabinose, xylose, glucose, fructose, mannose, galactose, maltose, cellobiose, sucrose, β-cyclodextrin, γ-cyclodextrin; and even more preferred are xylose, glucose, fructose, mannose, galactose, maltose, cellobiose, sucrose, xylitol, sorbitol.

The carbohydrate derivatives are available as commercial products, for example, from Tokyo Chemical, Aldrich or the like; or may be produced according to a known method of esterification of commercial carbohydrates (for example, according to the method described in JP-A 8-245678).

Preferably, the film of the invention is stretched, more preferably, in-line stretched. If desired, the film may be stretched in an additional step after once it is wound. Further, the in-line stretched film may be once wound and may be further stretched in an additional step. Thus stretched, the film may have a reduced haze and may have a reduced Nz factor value.

### [Polarizer]

The film of the invention is applicable to a polarizer, which comprises at least one film of the invention.

The polarizer of the invention preferably comprises a polarizing element and the film of the invention on one side of the polarizing element. Like the optical compensatory film of the invention, the embodiment of the polarizer includes not only an embodiment of a polarizer in the form of a film cut in a size capable of being directly incorporated in a liquid crystal display device but also an embodiment of a polarizer in the form of a long-size, rolled film (for example, an embodiment having a rolled length of 2500 m or more, or 3900 m or more). In order to be applicable to a large-panel liquid crystal display device, the width of the polarizer is preferably at least 1470 mm, as so mentioned in the above.

Regarding the constitution of the polarizer, there is no specific limitation thereon but a known constitution is employable. For example, the constitution of FIG. 6 in JP-A 2008-262161 is employable here.

It is preferable that a scrapped material is used as the film of the invention to thereby produce a polarizer of the invention showing a good reworkability.

### [Liquid Crystal Display Device]

The film of the invention is applicable to the liquid crystal display device comprising the above-mentioned polarizer.

The liquid crystal display device of the invention is a liquid crystal display device comprising a liquid crystal cell and a pair of polarizers arranged on both sides of the liquid crystal cell, in which at lest one polarizer is the polarizer of the invention. Preferably, the device is an IPS-mode, OCB-mode or VA-mode liquid crystal display device.

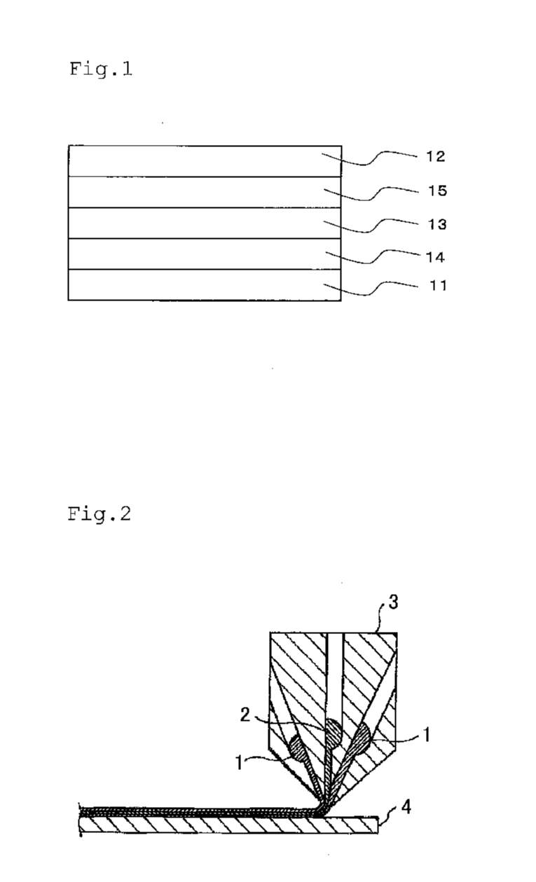

Regarding the constitution of the liquid crystal display device, there is no specific limitation thereon but a known constitution is employable. For example, the constitution of FIG. 1 is employable, or the constitution of FIG. 2 in JP-A 2008-262161 is also preferred.

It is preferable that a scrapped material is used as the film of the invention to thereby produce a liquid crystal display device of the invention showing a good reworkability. It is also preferable that a glass substrate is used as the liquid crystal cell to thereby produce a liquid crystal display device of the invention showing a good reworkability.

### [Production Method for Optical Film]

The production method for the optical film of the invention (hereinafter this may be referred to as the production method of the invention) comprises a step of dissolving at least two types of cellulose acylate resins that differ from each other in the total degree of acyl substitution therein, in a solvent to prepare a dope, and a step of casting the dope onto a metal support to form a film thereon, wherein the cellulose acylate resins include a cellulose acylate resin having a total degree of acyl substitution of less than 2.5 and a cellulose acylate resin having a total degree of acyl substitution of 2.5 or more, and of all the cellulose acylate resins constituting the dope, the cellulose acylate resin having the largest mass abundance ratio and the cellulose acylate resin having the second largest mass abundance ratio satisfy the following formula (1):

|A−B|×(b/a)≦0.13 (1)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

A preferred range of the formula (1) is the range of the formula (11), and a more preferred range thereof is the range of the formula (21).

The production method of the invention is described below.

Preferably, in the production method of the invention, the dope comprises at least three types of cellulose acylate resins differing from each other in the total degree of acyl substitution therein, of all the cellulose acylate resins constituting the dope, the cellulose acylate resin having the largest mass abundance ratio and the cellulose acylate resin having the third largest mass abundance ratio satisfy the following formula (2), and the mass abundance ratio of the cellulose acylate resin having the third largest mass abundance ratio is at least 2.5%:

|A−C|×(c/a)≦0.13 (2)

wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.

Also preferably in the production method of the invention, of all the cellulose acylate resins constituting the dope, the cellulose acylate resin having the largest mass abundance ratio and all the cellulose acylate resins having a mass abundance ratio of at least 2.5% satisfy the following formula (3):

|A−D|×(d/a)≦0.13 (3)

wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.

Also preferably in the production method of the invention, of all the cellulose acylate resins constituting the dope, all the cellulose acylate resins having a mass abundance ratio of at least 20% satisfy the following formula (A):

|P−Q|×(q/p)≦0.13 (A)

wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.

A preferred range of the formulae (2), (3) and (A) is the range of the formulae (12), (13) and (1A), respectively; and a more preferred range thereof is the range of the formulae (22), (23) and (2A), respectively.

The optical film is produced according to a solution casting method (solvent casting method). For production examples of cellulose acylate films according to a solvent casting method, for example, referred to are U.S. Pat. Nos. 2,336,310, 2,367,603, 2,492,078, 2,492,977, 2,492,978, 2,607,704, 2,739,069 and 2,739,070; BP 640731 and 736892; JP-B 45-4554 and 49-5614; JP-A 60-176834, 60-203430 and 62-115035. The cellulose acylate film may be stretched. Regarding the method and the condition for stretching treatment, for example, referred to are JP-A 62-115035, 4-152125, 4-284211, 4-298310 and 11-48271.

### <Preparation of Dope>

In the solvent casting method, a solution (dope) prepared by dissolving a cellulose acylate in an organic solvent is used for film production.

The organic solvent preferably contains an organic solvent selected from an ether having from 3 to 12 carbon atoms, a ketone having from 3 to 12 carbon atoms, an ester having from 3 to 12 carbon atoms, and a halogenohydrocarbon having from 1 to 6 carbon atoms. The ether, ketone and ester may have a cyclic structure. A compound having at least two functional groups of ether, ketone and ester (i.e., —O—, —CO— and —COO—) is also usable as the organic solvent. The organic solvent may have any other functional group such as an alcoholic hydroxyl group. When the organic solvent has two or more different types of functional groups, the number of the carbon atoms constituting the group may fall within the range defined for the compound having the functional group.

Examples of the ether having from 3 to 12 carbon atoms include diisopropyl ether, dimethoxymethane, dimethoxyethane, 1,4-dioxane, 1,3-dioxolan, tetrahydrofuran, anisole and phenetole.

Examples of the ketone having from 3 to 12 carbon atoms include acetone, methyl ethyl ketone, diethyl ketone, diisobutyl ketone, cyclohexane and methylcyclohexanone.

Examples of the ester having from 3 to 12 carbon atoms include ethyl formate, propyl formate, pentyl formate, methyl acetate, ethyl acetate and pentyl acetate.

Examples of the organic solvent having two or more different types of functional groups include 2-ethoxyethyl acetate, 2-methoxyethanol and 2-butoxyethanol.

The number of the carbon atoms constituting the halogenohydrocarbon is preferably 1 or 2, most preferably one.

Preferably, the halogen of the halogenohydrocarbon is chlorine. The proportion of substitution of the hydrogen atom in the halogenohydrocarbon with halogen is preferably from 25 to 75 mol %, more preferably from 30 to 70 mol %, even more preferably from 35 to 65 mol %, most preferably from 40 to 60 mol %. Methylene chloride is a typical halogenohydrocarbon.

Two or more different types of organic solvents may be mixed for use herein.

The cellulose acylate solution may be prepared according to an ordinary method. The ordinary method is meant to include treatment at a temperature of 0° C. or higher (room temperature or high temperature). The solution may be prepared according to a dope preparation method and using a dope preparation apparatus in an ordinary solvent casting method. In the ordinary method, a halogenohydrocarbon (especially methylene chloride) is preferred for the organic solvent.

The amount of the cellulose acylate is so controlled that the prepared solution could contain it in an amount of from 10 to 40% by mass. More preferably, the amount of the cellulose acylate is from 10 to 30% by mass. The preferred range of the cellulose acylate resin is the same as the preferred range thereof in the optical film of the invention, and the resin is preferably a cellulose acetate. The organic solvent (main solvent) may contain any additive of the above-mentioned additives that may be preferably in the optical film of the invention. In the production method of the invention, the dope preferably contains a phosphate compound or a non-phosphate oligomer compound.

The solution may be prepared by stirring a cellulose acylate and an organic solvent at room temperature (0 to 40° C.). A high-concentration solution may be stirred under pressure and under heat. Concretely, a cellulose acylate and an organic solvent are put in a pressure container and sealed up, and these are stirred under pressure and under heat at a temperature higher than room temperature but not higher than the boiling point of the organic solvent. The heating temperature is generally 40° C. or higher, preferably from 60 to 200° C., more preferably from 80 to 110° C.

The ingredients may be put in a reactor after they are roughly premixed. They may be sequentially put in a reactor. The reactor must be so designed that the contents therein could be stirred. An inert gas such as nitrogen gas may be introduced into the reactor to increase the pressure therein. The increase in the vapor pressure by heating may be utilized. Alternatively, after the reactor is sealed up, the constitutive ingredients may be put therein under pressure.

In case where the ingredients are heated, preferably, they are heated from the outside of the reactor. For example, a jacket-type heating apparatus may be used. A plate heater with a duct running therein may be arranged around the reactor, and a liquid may be circulated in the duct, whereby the reactor may be heated as a whole.

Preferably, a stirring blade is arranged inside the reactor, and the contents therein are stirred with it. Preferably, the stirring blade has a length that reaches around the wall of the reactor. Preferably, the tip of the stirring blade is provided with a scraper for renewing the liquid film around the wall of the reactor.

Instruments such as a pressure gauge, a thermometer and the like may be arranged in the reactor. In the reactor, the constitutive ingredients are dissolved in a solvent. The prepared dope may be taken out of the reactor after cooled therein, or may be taken out and then cooled with a heat exchanger or the like.

### (Use of Scrapped Material of Cellulose Acylate Resin-Containing Film)

Preferably in the production method of the invention, a cellulose acylate resin material that contains a scrapped material of a cellulose acylate resin-containing film is used as the cellulose acylate resin, from the viewpoint of reducing the production cost.

The scrapped material of a cellulose acylate resin-containing film may be a scrapped material of a once-formed cellulose acylate resin-containing resin film itself; however, in general, edges of a film that have heretofore been trimmed away in solution casting in an ordinary production method, or parts of bulk rolls with surface defects as well as parts of residual films used in other companies may be collected and may be used as the scrapped material of a cellulose acylate resin-containing film in the invention.

In case where a scrapped material of a once-formed cellulose acylate resin-containing film itself is used, it may be crushed with a film crusher into pieces having a desired size.

In case where edges of a film in solution casting are used, they may be prepared to have a desired size. Preferably, the edges of a film are crushed into pieces having a size of at most 10 mm square, more preferably at most 6 mm square.

Of those, in case where a scrapped material of a cellulose acylate resin-containing film is used in the production method of the invention, use of edges of a film is preferred from the viewpoint of reducing the amount of the material to be used and reducing the environmental load.

A scrapped material of a cellulose acylate resin-containing film may be used for the dope for core layer or for the dope for outermost layer. If possible, the scrapped film is separated into the core layer and the outermost layer, and the part of the core layer is used as the dope for core layer of a film to be produced, and the part of the outermost layer is used as the dope for outermost layer.

The scrapped material of a cellulose acylate resin-containing film may be a scrapped material of the optical film of the invention, or a scrapped material of any other cellulose acylate resin-containing film than the film of the invention.

In the production method of the invention, preferably, the scrapped material of a cellulose acylate resin-containing film is a scrapped material of the optical film of the invention from the viewpoint of stabilizing the distribution of the total degree of acyl substitution in the cellulose acylate resin and preventing the formed film from whitening.

In the production method of the invention, in case where a scrapped material of a cellulose acylate film composed of two or more layers is used, preferably, the scrapped material of the cellulose acylate resin-containing film is used as the cellulose acylate resin in the dope for core layer, and more preferably, only the core layer of the cellulose acylate resin-containing multilayer film is collected as a scrapped material and the thus collected scrapped material is used as the cellulose acylate resin for the dope for core layer.

In the production method of the invention, in case where a scraped material of a cellulose acylate resin-containing single-layer film, which comprises two or more types of cellulose acylate resins differing from each other in the total degree of acyl substitution therein, is used, its amount to be used is preferably optimized in consideration of the substitution degree and in accordance with the object of the invention.

In the production method of the invention, the proportion of the scrapped material of a cellulose acylate resin-containing film to all the cellulose acylate resins in the dope is preferably from more than 10% by mass to 80% by mass, from the viewpoint of reducing the amount of the material to be used and reducing the environmental load, more preferably from 10 to 60% by mass, even more preferably from 10 to 50% by mass.

### <Casting Method>

As the solution casting method, there are known an extrusion method of uniformly extruding a prepared dope from a pressure die onto a metal support, a doctor blade method where the dope once cast on a metal support is treated with a blade to control its thickness, and a reverse roll method of controlling a once-cast dope with a reverse roll coater. Preferred is the method through a pressure die. The pressure die includes a coat hanger type one or a T-die type one, and any of these is preferably used here. Apart from the methods mentioned herein, any other various known solution-casting methods using various known cellulose triacetate solutions may be employed here. Taking the difference in boiling point and others between the solvents to be used into consideration and defining various conditions, various solution casting methods may be effected to attain the same effects as those described in the related references.

In the production method of the invention, preferably, the viscosity at 25° C. of the solution of cellulose acylate for the low-substitution degree layer is higher by at least 10% than the viscosity at 25° C. of the solution of cellulose acylate for the high-substitution degree layer, from the viewpoint of the cross-direction distribution of the laminate film layers and of the laminate film production aptitude.

### (Co-Casting)

In producing the film of the invention, preferred is a lamination casting method of a co-casting method, a successive-casting method, a coating method or the like. More preferred is a simultaneous co-casting method or a successive-casting method; and even more preferred is a simultaneous co-casting method from the viewpoint of stable production and production cost reduction.

In case where the film of the invention is produced according to a co-casting method or a successive-casting method, the cellulose acylate solution (dope) for each layer is first prepared.

In the production method of the invention, at least one dope for outermost layer and at least one dope for core layer are used; and, preferably, the dopes are successively cast or simultaneously co-cast in such a manner that the dope for outermost layer could form the film outermost layer on the side in contact with the metal support, thereby producing a cellulose acylate laminate film.

More preferably in the production method of the invention, the dopes are successively cast or simultaneously co-cast in such a manner that the dope for outermost layer could form the film outermost layer on the side not in contact with the metal support, thereby producing a cellulose acylate laminate film.

Preferably in the production method of the invention, the dope for core layer comprises at least two types of cellulose acylate resins differing in the total degree of acyl substitution therein, of the cellulose acylate resins constituting the dope for core layer, the cellulose acylate resin having the largest mass abundance ratio and the cellulose acylate resin having the second largest mass abundance ratio satisfy the following formula (4):

|A−B|×(b/a)≦0.10 (4)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

A preferred range of the formula (4) is the range of the formula (14), and a more preferred range thereof is the range of the formula (24).

Preferably in the production method of the invention, the dope for core layer comprises at least three types of cellulose acylate resins differing from each other in the total degree of acyl substitution therein, of all the cellulose acylate resins constituting the dope for core layer, the cellulose acylate resin having the largest mass abundance ratio and the cellulose acylate resin having the third largest mass abundance ratio satisfy the following formula (5), and the mass abundance ratio of the cellulose acylate resin having the third largest mass abundance ratio is at least 2.5%:

|A−C|×(c/a)≦0.10 (5)

wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.

In the production method of the invention, preferably, of all the cellulose acylate resins constituting the dope for core layer, the cellulose acylate resin having the largest mass abundance ratio and all the cellulose acylate resins having a mass abundance ratio of at least 2.5% satisfy the following formula (6):

|A−D|×(d/a)≦0.13 (6)

wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.

In the production method of the invention, preferably, of all the cellulose acylate resins constituting the dope for core layer, all the cellulose acylate resins having a mass abundance ratio of at least 20% satisfy the following formula (B):

|P−Q|×(q/p)≦0.13 (B)

wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.

A preferred range of the formulae (5), (6) and (B) is the range of the formulae (15), (16) and (1B), respectively; and a more preferred range thereof is the range of the formulae (25), (26) and (2B), respectively.

Preferably in the production method of the invention, any one of the cellulose acylate resin having the largest mass abundance ratio and the cellulose acylate resin having the second largest mass abundance ratio is a cellulose acylate resin having a total degree of acyl substitution of less than 2.5, and the other is a cellulose acylate resin having a total degree of acyl substitution of 2.5 or more.

Also preferably in the production method of the invention, the cellulose acylate resin having the largest mass abundance ratio is a cellulose acylate resin having a total degree of acyl substitution of less than 2.5, and the cellulose acylate resin having the second largest mass abundance ratio is a cellulose acylate resin having a total degree of acyl substitution of 2.5 or more.

Preferably in the production method of the invention, the mean value Z of the total degree of acyl substitution in the cellulose acylate resins constituting the dope for core layer satisfies the following formula (7):

2.1<Z<2.5. (7)

In the production method of the invention, preferably, of the dopes for outermost layer, at least the cellulose acylate resin constituting the dope for outermost layer to form the film outermost layer on the side in contact with the metal support is a cellulose acylate resin having a total degree of acyl substitution of 2.5 or more on average.

Preferably in the production method of the invention, the dope for outermost layer to form both outermost layers of the film is a cellulose acylate resin having a total degree of acyl substitution of at least 2.5 on average.

In the co-casting method (multilayer simultaneous casting method), co-casting dopes are simultaneously extruded out through a casting Giesser through which the individual casting dopes for the intended layers (two or more layers) are simultaneously cast via different slits onto a casting metal support (band or drum), and at a suitable time, the film formed on the metal support is peeled away and dried. FIG. 2 is a cross-sectional view showing a mode of simultaneous extrusion to form three layers by casting the dope 1 for surface layer (outermost layer) and the dope 2 for core layer on a casting metal support 4 through a co-casting Giesser 3.

The successive-casting method is as follows: First the dope for outermost layer is extruded out and cast onto a casting metal support through a casting Giesser, then after it is dried or not dried, the casting dope for second layer (core layer) is cast onto it in a mode of extrusion through a casting Giesser, and if desired, three or more layers are successively formed in the same mode of casting and lamination, and at a suitable time, the resulting laminate film is peeled away from the metal support and dried.

On the other hand, the coating method is as follows: A film of a core layer is formed according to a solution casting method, then a coating solution for surface layer is prepared, and using a suitable coater, the coating solution is applied onto the previously formed core film first on one surface thereof and next on the other surface thereof, or simultaneously on both surfaces thereof, and the resulting laminate film is dried.

As the endlessly running metal support for use in producing the film of the invention, preferably usable is a drum of which the surface is mirror-finished by chromium plating, or a SUS (stainless) belt (band) of which the surface is mirror-finished by polishing. One or more pressure dies may be arranged above the metal support. Preferably, one or two pressure dies are arranged. In case where two or more pressure dies are arranged, the dope to be cast may be divided into portions suitable for the individual dies; or the dope may be fed to the die at a suitable proportion via a plurality of precision metering gear pumps. The temperature of the cellulose acylate solution to be case is preferably from −10 to 55° C., more preferably from 25 to 50° C. In this case, the solution temperature may be the same throughout the entire process, or may differ in different sites of the process. In case where the temperature differs in different sites, the dope shall have the desired temperature just before cast.

### <Stretching Treatment>

The production method of the invention preferably includes a step of stretching the formed cellulose acylate laminate film at a temperature of not lower than (Tg−30° C.) under the condition that the film contains the residual solvent in an amount of at least 5% by mass of the film. As described in the above, the optical compensatory film of the invention is characterized by readily having improved wavelength dispersion characteristics of retardation; and the stretching treatment makes it possible to impart the optical property to the stretched film and to impart the desired retardation thereto. The stretching direction of the cellulose acylate film may be preferably any of the film traveling direction or the direction perpendicular to the film traveling direction (cross direction). More preferably, the film is stretched in the direction perpendicular to the film traveling direction (cross direction) from the viewpoint of the subsequent process of using the film for producing a polarizer.

The method of stretching in the cross direction is described, for example, in JP-A 62-115035, 4-152125, 4-284211, 4-298310, 11-48271. For the machine-direction stretching, for example, the speed of the film conveyor rollers is regulated so that the film winding speed could be higher than the film peeling speed whereby the film may be stretched. For the cross-direction stretching, the film is conveyed while held by a tenter at the sides thereof and the tenter width is gradually broadened, whereby the film can be stretched. After dried, the film may be stretched with a stretcher (preferably for monoaxial stretching with a long stretcher).

The draw ratio in stretching of the film of the invention is preferably from 5% to 200%, more preferably from 10% to 100%, even more preferably from 20% to 50%.

In case where the cellulose acylate film is used as a protective film for a polarizing element, the transmission axis of the polarizing element must be in parallel to the in-plane slow axis of the cellulose acylate film so as to prevent the light leakage in oblique directions to the polarizer. The transmission axis of the roll film-type polarizing element that is produced continuously is generally parallel to the cross direction of the roll film, and therefore, in continuously sticking the roll film-type polarizing element and a protective film of a roll film-type cellulose acylate film, the in-plane slow axis of the roll film-type protective film must be parallel to the cross direction of the film. Accordingly, the film is preferably stretched to a larger extend in the cross direction. The stretching treatment may be attained during the course of the film formation process, or the wound film may be unwound and stretched. In the production method of the invention, the film is stretched while it contains the residual solvent therein, and therefore the film is preferably stretched during the course of the film formation process.

### <Drying>

Preferably, the production method of the invention includes a step of drying the cellulose acylate laminate film and a step of stretching the dried cellulose acylate laminate film at a temperature not lower than (Tg−10° C.), from the viewpoint of enhancing the retardation of the film.

For drying the dope on a metal support in production of a cellulose acylate film, generally employable is a method of applying hot air to the surface of the metal support (drum or belt), or that is, on the surface of the web on the metal support; a method of applying hot air to the back of the drum or belt; or a back side liquid heat transfer method that comprises contacting a temperature-controlled liquid with the opposite side of the dope-cast surface of the belt or drum, or that is, the back of the belt or drum to thereby heat the belt or drum by heat transmission to control the surface temperature thereof. Preferred is the backside liquid heat transfer method. The surface temperature of the metal support before the dope is cast thereon may be any degree so far as it is not higher than the boiling point of the solvent used in the dope. However, for promoting the drying or for making the dope lose its flowability on the metal support, preferably, the temperature is set to be lower by from 1 to 10° C. than the boiling point of the solvent having the lowest boiling point of all the solvents in the dope. In case where the cast dope is peeled off after cooled but not dried, then this shall not apply thereto.

For controlling the thickness of the film, the solid concentration in the dope, the slit gap of the die nozzle, the extrusion pressure from the die, and the metal support speed may be suitably regulated so that the formed film could have a desired thickness.

### <Rolling Up>

The cellulose acylate film produced in the manner as above is preferably rolled up so that the length of the cellulose acylate film is preferably from 100 to 10000 m per roll, more preferably from 50 to 7000 m, even more preferably from 1000 to 6000 m. In winding the film, preferably, at least one edge thereof is knurled, and the knurling width is preferably from 3 mm to 50 mm, more preferably from 5 mm to 30 mm, and the knurling height is preferably from 0.5 to 500 μm, more preferably from 1 to 200 μm. This may be one-way or double-way knurling.

In general, in large-panel display devices, contrast reduction and color shift may be remarkable in oblique directions; and therefore the film of the invention is especially suitable for use in large-panel display devices. In case where the film of the invention is used as an optical compensatory film for large-panel liquid crystal display devices, for example, the film is shaped to have a width of at least 1470 mm. The optical compensatory film of the invention includes not only film sheets cut to have a size that may be directly incorporated in liquid crystal display devices but also long films continuously produced and rolled up into rolls. The optical compensatory film of the latter embodiment is stored and transported in the rolled form, and is cut into a desired size when it is actually incorporated into a liquid crystal display device or when it is stuck to a polarizing element or the like. The long film may be stuck to a polarizing element formed of a long polyvinyl alcohol film directly as they are, and then when this is actually incorporated into a liquid crystal display device, it may be cut into a desired size. One embodiment of the long optical compensatory film rolled up into a roll may have a length of 2500 m/roll or more.

### EXAMPLES

The invention is described more concretely with reference to the following Examples. In the following Examples, the materials, the reagents and the substances used, their amount and ratio, the details of the treatment and the treatment process may be suitably modified or changed not overstepping the sprit and the scope of the invention. Accordingly, the invention should not be limitatively interpreted by the Examples mentioned below.

In the invention, the film samples were analyzed according to the methods mentioned below.

### (Evaluation by HPLC-CAD)

Of the formed film, the left-hand value of the following formula (1) for the cellulose acylate resin having the largest mass abundance ratio and the cellulose acylate resin having the second largest mass abundance ratio in the entire film was computed:

|A−B|×(b/a)≦0.13 (1)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

A film center part sample separated from both surfaces of the film by at least 20% in the film thickness direction was prepared by cutting the two surfaces of the film with a cutter knife, and of the center part sample, the left-hand value of the following formula (4) was computed:

|A−B|×(b/a)≦0.10 (4)

wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

The computed data are shown in the Table below.

The HPLC apparatus used in the HPLC-CAD method in the invention is Shimadzu's Model LC-2010HT, and the HPLC condition was as follows:

Linear gradient detector with solvent from CHCl₃/MeOH (90/10 (v/v)):MeOH.H₂O (8/1 (v/v))=20/80 to CHCl₃.MeOH (9/1) for 30 min.
Normal phase partition mode.

### Column: Novapak Phenyl (Waters), 3.9φ×150 mm.

Flow rate: 1.0 ml/min.

CAD used in the HPLC-CAD method in the invention is Corona's Model CAD™ HPLC Detector, and the condition for detection with CAD was as follows:

Column temperature: 30° C.
Sample concentration: 0.002% by mass.
Sample amount: 50 μL.

### (Peelability)

The formed film was checked for the peelability thereof according to the method mentioned below.

A dope prepared to have a solid concentration of 20% by mass was cast onto SUS having a controlled temperature of 25° C. in such a manner that the dry thickness thereof could be 80 μm, then the film was kept as such for 120 seconds and thereafter peeled away. In peeling, the load applied to the film was detected with a load cell, and its value was read.

The found data were evaluated according to the criteria mentioned below, and the results are shown in the Table below.

O: From 0 to less than 70 gf/cm.
x: 70 gf/cm or more.

### (Film Whitening)

The formed film was checked for whitening according to the method mentioned below.

The haze and the internal haze of the film were measured.

Concretely, the film sample having a size of 40 mm×80 mm was coated with liquid paraffin on both surfaces thereof, and then sandwiched between glass sheets. Using a haze mater (Saga Test Instruments' HGM-2DP), this was analyzed at 25° C. and relative humidity 60% according to JIS K-6714. A blank sample of liquid paraffin and glass sheets alone with no film sandwiched therebetween was analyzed in the same manner. The found data were evaluated according to the criteria mentioned below, and the results are shown in the Table below.

O: Haze, at most 1.0; internal haze, less than 0.1.
Δ: Haze, at most 1.5; internal haze, less than 0.15.
x: Haze, more than 1.5; internal haze, 0.15 or more.

### (Optical Expressibility)

The formed film was analyzed for the optical expressibility thereof according to the method mentioned below.

First, a dry film sample was analyzed with Vibron, and its tan δ peak temperature was estimated.

At a temperature of the tan δ peak temperature −10° C., the film sample was monoaxially stretched by 1.3 times with its edges fixed in the direction vertical to the film traveling direction. Using an automatic birefringence meter KOBRA-WR (by Oji Scientific Instruments), the in-plane retardation Re of the film sample was analyzed to measure its three-dimensional birefringence at a wavelength of 550 nm. The thickness-direction retardation Rth of the film sample was determined by measuring Re at different tilt angles.

Re is represented by A and The thickness-direction retardation Rth is by B, and the found data were evaluated according to the following criteria. The results are shown in the Table below.

### O: A>45 nm, B>100 nm

### Δ: 30<A≦45 nm, 80<B≦100 nm.

x: 30≧nm A, 80 nm≧B.

### (Reworkability Test)

The cellulose acylate film was subject to the following immersion saponification. A similar result was obtained by subjecting the cellulose acylate film to coating saponification.

### (1-1) Immersion Saponification

An aqueous solution of NaOH (1.5 mol/L) maintained at 60° C. was used as a saponification solution. The cellulose acylate film was immersed in the saponification solution for 2 minutes and then in an aqueous solution of a sulfuric acid (0.05 mol/L) for 30 seconds. The film was passed through a water bath for washing.

### (1-2) Coating Saponification

Water (20 parts by mass) was added to isopropanol (80 parts by mass) and KOH was added and dissolved in an amount of 1.5 mol/L. The solution was maintained at 60° C. and it is used as a saponification solution. The saponification solution was coated on the cellulose acylate film at 60° C. in an amounto of 10 g/m² and saponification was conducted for 1 minutes. Then the film was washed by spraying hot water at 50° C. at a rate of 10 L/m²/minute.

### (2) Production of Polarizing Element

According to the Example 1 of JP-A 2001-141926, the film was stretched to the machine direction to produce a polarizing element of 20 μm thick while two pairs of nip rolls were moved at different peripheral speed.

### (3) Sticking Together

Thus obtained polarizing element is stuck to the saponified film obtained above with a 3% aqueous solution adhesive of PVA (PVA-117H manufactured by Kuraray) so that the transmission axis of the polarizing element could cross the longitudinal direction of the cellulose acylate film by 45 degrees. The produced polarizer is stuck to a glass plate of a liquid crystal display device with an adhesive while the optically compensatory film faces the glass plate of the liquid crystal display device, and subjected to aging at 50° C. under 5 atm for 6 hours. The polarizer was peeled off from the glass plate at 25° C. and 60% RH. The process was repeated on 100 samples. The surface of each glass plate was observed to check the remaining material that had not been peeled and evaluated according to the following criteria. The results are shown in the Table below.

O: No remaining materials were observed.
x: Areas of remaining materials were observed.

### [A: Blending by Collection of Chips of Co-Cast Film]

### (1) Preparation of Cellulose Acylate Resin by Synthesis:

A cellulose acylate having a degree of acyl substitution shown in Table 1 was prepared. As a catalyst, sulfuric acid (in an amount of 7.8 parts by mass relative to 100 parts by mass of cellulose) was added; and a carboxylic acid was added for acylation at 40° C. Subsequently, by controlling the amount of the sulfuric acid catalyst, the amount of water and the ripening time, the total degree of substitution and the degree of 6-substitution were controlled. The ripening temperature was 40° C. A low-molecular weight component was removed from the cellulose acylate by washing with acetone.

### (2) Preparation of Cellulose Acylate Resin by Collection of Chips of the Formed Cellulose Acylate Film:

According to the method mentioned below, chips of the cellulose acylate film having a total degree of acyl substitution shown in Table 1 below were collected as a scrapped material.

From the edge of the stretched film, the film was cut to a width of 200 mm including the clipped part thereof, and the chips were crushed with a film crusher (cutter blade). Thus crushed, the size of the film pieces was nearly uniform and was 5 mm square.

Regarding the type of the scrapped material used herein as to whether it is a scrapped material of the optical film of the invention or a scrapped material of any other cellulose acylate film satisfying the total degree of acyl substitution shown in Table 1 below, the cellulose acylate resins used herein are shown in Table 1 below.

The proportion of the scrapped material in the cellulose acylate resin used for the dope for core layer and the dope for outermost layer is shown in Table 1 below.

### (3) Preparation of Dope:

### <3-1> Cellulose Acylate Dope for Core Layer:

The ingredients mentioned were put into a mixing tank, stirred and dissolved, then heated at 90° C. for about 10 minutes. Subsequently, the mixture was filtered through a paper filter having a mean pore size of 34 μm and through a sintered metal filter having a mean pore size of 10 μm.

Cellulose acylate dope for core layer of Comparative Example 1

| | |
|---|---|
| Cellulose acetate (having a degree of substitution | 100.0 parts by mass |
| of 2.41 - the type of the scrapped material and the | |
| proportion of the scrapped material are shown in | |
| Table 1) | |
| Compound A | 18.5 parts by mass |
| Methylene chloride | 365.5 parts by mass |
| Methanol | 54.6 parts by mass |

Other cellulose acylate dopes for core layer were produced in the same manner as that for the above-mentioned cellulose acylate dope for core layer of Comparative Example 1, except that the degree of substitution of cellulose acylate, the type of the scrapped material, the proportion of the scrapped material, the type of the additive and the amount of the additive were changed as in Table 1 below. The details of Additives A to E are shown in Table 3 below.

Additive F is a plasticizer TPP/BDP.

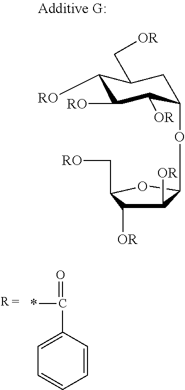

The amount of the additive is “part by mass” relative to 100 parts by mass of the amount of the cellulose acylate in the composition.

### <3-2> Cellulose Acylate Dope for Outermost Layer:

The ingredients mentioned were put into a mixing tank, stirred and dissolved, then heated at 90° C. for about 10 minutes. Subsequently, the mixture was filtered through a paper filter having a mean pore size of 34 μm and through a sintered metal filter having a mean pore size of 10 μm.

Cellulose acylate dope for outermost layer of Comparative
Example 1

| | |
|---|---|
| Cellulose acetate (having a degree of substitution | 100.0 parts by mas |
| of 2.41 - the type of the scrapped material and the | |
| proportion of the scrapped material are shown in | |
| Table 1) | |
| Compound A | 11.0 parts by mass |
| Methylene chloride | 365.5 parts by mass |
| Methanol | 54.6 parts by mass |

Other cellulose acylate dopes for outermost layer were produced in the same manner as that for the above-mentioned cellulose acylate dope for outermost layer of Comparative Example 1, except that the degree of substitution of cellulose acylate, the type of the scrapped material, the proportion of the scrapped material, the type of the additive and the amount of the additive were changed as in Table 1 below.

### (Co-Casting)

The cellulose acylate solution for low-substitution layer and the cellulose acylate solution for high-substitution layer were co-cast in such a manner that they could form a core layer and an outermost layer having the thickness ratio as in Table 1 below. The band was a SUS band. The formed web (film) was peeled away from the band, and clipped; and while the residual solvent amount in the film was from 30 to 5% of the total mass of the film, the film was laterally stretched using a tenter under the condition of edge-fixed monoaxial stretching. Subsequently, the film was unclipped, and dried at 130° C. for 20 minutes. In this step, the casting film thickness was so controlled that the thickness of the stretched film could be as in Table 1 (unit: μm). The films each having the composition shown in Table 1 were produced. For determining the production aptitude of the films, at least 24 rolls of each film having a width of 1280 mm and a length of 2600 mm were produced under the above-mentioned condition. Of 24 rolls thus continuously produced, the film of one roll was sampled at intervals of 100 m to give film samples each having a length of 1 m (and having a width of 1280 mm). The film samples were tested and analyzed.

The obtained results are shown in Table 1 below.

TABLE 1

| | Dope for Core Layer | | | | | | Dope for Outermost Layer | | | | | |
|---|---|---|---|---|---|---|---|---|---|---|---|---|
| | | | | | | | | | | | | total |
| | Cellulose Acylate Resin | | | | | | Cellulose Acylate Resin | | | | | thickness |
| | | total | | proportion | Additive | | | | proportion | Additive | | of |
| | | degree of | | of scrapped | | amount | | total degree | of scrapped | | amount | outermost |
| | acyl | acyl sub- | type of scrapped | material | | (part by | acyl | of acyl | material | | (part by | layers |
| | group | stitution | material | (mas %) | type | mass) | group | substitution | (mas %) | type | mass) | (μm) |
| Comparative | acetyl | 2.41 | film of Comparative | 40 | A | 18.5 | acetyl | 2.81 | 0 | A | 11 | 10 |
| Example 1 | | | Example 1 | | | | | | | | | |
| Example 1 | acetyl | 2.41 | film of Example 1 | 30 | A | 18.5 | acatyl | 2.81 | 0 | A | 11 | 8 |
| Example 2 | acetyl | 2.41 | film of Example 2 | 30 | A | 18.5 | acetyl | 2.81 | 0 | A | 11 | 6 |
| Example 3 | acetyl | 2.41 | film of Example 3 | 70 | A | 18.5 | acetyl | 2.81 | 0 | A | 11 | 4 |
| Example 4 | acetyl | 2.41 | film of Example 4 | 75 | A | 18.5 | acetyl | 2.81 | 0 | A | 11 | 2 |
| Comparative | acetyl | 2.41 | film of Comparative | 10 | A | 18.5 | — | — | 0 | — | — | 0 |
| Example 2 | | | Example 2 | | | | | | | | | |
| Comparative | acetyl | 2.05 | film of Comparative | 20 | A | 18.5 | acetyl | 2.81 | 0 | A | 11 | 4 |
| Example 3 | | | Example 3 | | | | | | | | | |
| Example 5 | acetyl | 2.2 | film of Example 5 | 30 | A | 18.5 | acetyl | 2.81 | 0 | A | 11 | 4 |
| Example 6 | acetyl | 2.48 | film of Example 6 | 30 | A | 18.5 | acetyl | 2.81 | 0 | A | 11 | 4 |
| Comparative | acetyl | 2.6 | film of Comparative | 30 | A | 18.5 | acetyl | 2.81 | 0 | A | 11 | 4 |
| Example 4 | | | Example 4 | | | | | | | | | |
| Comparative | acetyl | 2.75 | film of Comparative | 30 | A | 18.5 | acetyl | 2.81 | 0 | A | 11 | 4 |
| Example 5 | | | Example 5 | | | | | | | | | |
| Example 7 | acetyl | 2.41 | film of Example 7 | 30 | B | 18.5 | acetyl | 2.81 | 0 | B | 11 | 4 |
| Example 8 | acetyl | 2.41 | film of Example 8 | 30 | C | 18.5 | acetyl | 2.81 | 0 | C | 11 | 4 |
| Example 9 | acetyl | 2.41 | film of Example 9 | 30 | D | 18.5 | acetyl | 2.81 | 0 | D | 11 | 4 |
| Example 10 | acetyl | 2.41 | film of Example 10 | 30 | E | 18.5 | acetyl | 2.81 | 0 | E | 11 | 4 |
| Example 11 | acetyl | 2.41 | film of Example 11 | 30 | F | 18.5 | acetyl | 2.81 | 0 | F | 11 | 4 |

| | Laminate Film | | | | | |
|---|---|---|---|---|---|---|
| | thickness of outermost | value of (Δ substitution | | | | |
| | layer/(thickness of | degree) × (area ratio) | | Test Results | | |
| | outermost layer + | by HPLC-CAD | | | | optical |
| | thickness of | whole | center | peel- | film | express- |
| | core layer) | film | part | ability | whitening | ibility |
| Comparative | 0.14 | 0.14 | 0.10 | ◯ | X | ◯ |
| Example 1 | | | | | | |
| Example 1 | 0.11 | 0.13 | 0.04 | ◯ | Δ | ◯ |
| Example 2 | 0.09 | 0.10 | 0.04 | ◯ | ◯ | ◯ |
| Example 3 | 0.06 | 0.05 | 0.04 | ◯ | ◯ | ◯ |
| Example 4 | 0.03 | 0.02 | 0.04 | ◯ | ◯ | ◯ |
| Comparative | 0.00 | 0.00 | 0.00 | X | ◯ | ◯ |
| Example 2 | | | | | | |
| Comparative | 0.03 | 0.15 | 0.11 | ◯ | X | ◯ |
| Example 3 | | | | | | |
| Example 5 | 0.03 | 0.13 | 0.09 | ◯ | Δ | ◯ |
| Example 6 | 0.03 | 0.04 | 0.04 | ◯ | ◯ | ◯ |
| Comparative | 0.03 | 0.03 | 0.02 | ◯ | ◯ | X |
| Example 4 | | | | | | |
| Comparative | 0.03 | 0.02 | 0.01 | ◯ | ◯ | X |
| Example 5 | | | | | | |
| Example 7 | 0.03 | 0.02 | 0.04 | ◯ | ◯ | ◯ |
| Example 8 | 0.03 | 0.02 | 0.04 | ◯ | ◯ | ◯ |
| Example 9 | 0.03 | 0.02 | 0.04 | ◯ | ◯ | ◯ |
| Example 10 | 0.03 | 0.02 | 0.04 | ◯ | ◯ | ◯ |
| Example 11 | 0.03 | 0.02 | 0.04 | ◯ | ◯ | ◯ |

From Table 1, it is known that the optical films of the invention contain at least a cellulose acylate resin having a total degree of acyl substitution of less than 2.5, and have good peelability from the metal support in solution casting, and do not whiten, and have good optical expressibility. It is also known that, according to the optical film production method of the invention, a scrapped material is used, and therefore the production cost for the optical films of the invention is reduced and the reworkability evaluated by the above test is improved.

It has been confirmed that the films of the invention shown in Table 1 all satisfy the above-mentioned formulae (2) and (3) and the formula (A).

Further, it has been confirmed that all the cellulose acylate resins constituting the film center part of the films of the invention shown in Table 1 satisfy the above-mentioned formulae (5) and (6) and the formula (B), in which the mass abundance ratio of the cellulose acylate resin having the third largest mass abundance ratio is at least 2.5%.

In addition, it has been confirmed that the films of the invention in Table 1 all have improved heat durability and wet heat durability.

### [B: Blending by Collection of Chips of Single-Layer Cellulose Acylate Resin Film]

### (1) Preparation of Cellulose Acylate Resin by Synthesis:

A cellulose acylate having a degree of acyl substitution shown in Table 2 was prepared. As a catalyst, sulfuric acid (in an amount of 7.8 parts by mass relative to 100 parts by mass of cellulose) was added; and a carboxylic acid was added for acylation at 40° C. Subsequently, by controlling the amount of the sulfuric acid catalyst, the amount of water and the ripening time, the total degree of substitution and the degree of 6-substitution were controlled. The ripening temperature was 40° C. A low-molecular weight component was removed from the cellulose acylate by washing with acetone.

### (2) Preparation of Cellulose Acylate Resin by Collection of Chips of the Formed Cellulose Acylate Film:

According to the method mentioned below, chips of the cellulose acylate film having a total degree of acyl substitution shown in Table 2 below were collected as a scrapped material.

From the edge of the stretched film, the film was out to a width of 200 mm including the clipped part thereof, and the chips were crushed with a film crusher (cutter blade). Thus crushed, the size of the film pieces was nearly uniform and was 5 mm square.

Regarding the type of the scrapped material used herein as to whether it is a scrapped material of the optical film of the invention or a scrapped material of any other cellulose acylate film satisfying the total degree of acyl substitution shown in Table 2 below, the cellulose acylate resins used herein are shown in Table 2 below.

The proportion of the scrapped material in the cellulose acylate resin used in the cellulose acylate resin dopes 1 and 2 is shown in Table 2 below.

### (3) Preparation of Dope:

The ingredients mentioned were put into a mixing tank, stirred and dissolved, then heated at 90° C. for about 10 minutes. Subsequently, the mixture was filtered through a paper filter having a mean pore size of 34 μm and through a sintered metal filter having a mean pore size of 10 μm.

Cellulose acylate dope 1 in Comparative Example 101

| | |
|---|---|
| Cellulose propionate (having a degree of | 100.0 parts by mas |
| substitution of 2.41 - the type of the scrapped | |
| material and the proportion of the scrapped | |
| material are shown in Table 2) | |
| Compound A | 10.0 parts by mass |
| Methylene chloride | 365.5 parts by mass |
| Methanol | 54.6 parts by mass |

Cellulose acylate resin dopes 1 and 2 in other Examples and Comparative Examples were produced in the same manner as that for the cellulose acylate resin dope 1 in Comparative Example 101, except that the type of the acyl group in cellulose acylate resin, the degree of substitution, the type of the scrapped material, the proportion of the scrapped material, the type of the additive and the amount of the additive were changed as in Table 2 below.

### (Casting)

The above-mentioned dope was cast, using a band caster. The band was a SUS band. On the band, the film was dried for which the air supply temperature was 80° C. to 130° C. and the exhaust temperature was 75° C. to 120° C. The film having a residual solvent amount of from 25 to 35% by mass was peeled away from the band, and in a tenter zone having an air supply temperature of 140° C. and an exhaust temperature of 90° C. to 125° C., this was stretched in the lateral direction at a draw ratio of from 10% to 50%, thereby producing a cellulose acylate film. In this step, the casting film thickness was so controlled that the thickness of the stretched film could be as in Table 2 (unit: μm). The films each having the composition shown in Table 2 were produced. For determining the production aptitude of the films, at least 24 rolls of each film having a width of 1280 mm and a length of 2600 m were produced under the above-mentioned condition. Of 24 rolls thus continuously produced, the film of one roll was sampled at intervals of 100 m to give film samples each having a length of 1 m (and having a width of 1280 mm). The film samples were tested and analyzed.

The obtained results are shown in Table 2 below.

TABLE 2

| | All Cellulose Acylate Resin Dopes | | | | | | | |
|---|---|---|---|---|---|---|---|---|
| | Cellulose Acylate Resin Dopes Produced from Cotton | | | | | | | |
| | Cellulose Acylate Resin Dope 1 | | | | Cellulose Acylate Resin Dope 2 | | | |
| | cellulose acylate resin | | | | cellulose acylate resin | | | |
| | | total degree | additive | | | total degree | additive | |
| | acyl | of acyl | | amount | acyl | of acyl | | amount |
| | group | substitution | type | (part by mass) | group | substitution | type | (part by mass) |
| Comparative | propionyl | 2.41 | G | 10 | — | — | — | — |
| Example 101 | | | | | | | | |
| Comparative | propionyl | 2.41 | G | 10 | propionyl | 2.43 | G | 10 |
| Example 102 | | | | | | | | |
| Example 101 | propionyl | 2.45 | G | 10 | propionyl | 2.52 | G | 10 |
| Comparative | propionyl | 2.51 | G | 10 | propionyl | 2.75 | G | 10 |
| Example 103 | | | | | | | | |
| Comparative | propionyl | 2.35 | G | 10 | propionyl | 2.81 | G | 10 |
| Example 104 | | | | | | | | |
| Comparative | propionyl | 2.45 | G | 10 | propionyl | 2.35 | G | 10 |
| Example 105 | | | | | | | | |
| Example 102 | propionyl | 2.45 | G | 10 | propionyl | 2.51 | G | 10 |
| Example 103 | propionyl | 2.45 | G | 10 | propionyl | 2.71 | G | 10 |
| Comparative | propionyl | 2.45 | G | 10 | propionyl | 2.85 | G | 10 |
| Example 106 | | | | | | | | |
| Comparative | propionyl | 2.55 | G | 10 | propionyl | 2.85 | G | 10 |
| Example 107 | | | | | | | | |
| Comparative | acetyl | 2.43 | A | 18 | — | — | — | — |
| Example 108 | | | | | | | | |
| Example 104 | acetyl | 2.33 | A | 18 | acetyl | 2.81 | A | 10 |
| Example 105 | acetyl | 2.43 | A | 18 | acetyl | 2.81 | A | 10 |
| Comparative | acetyl | 2.55 | A | 18 | acetyl | 2.81 | A | 10 |
| Example 107 | | | | | | | | |
| Example 106 | acetyl | 2.35/2.41 | A | 18 | acetyl | 2.81 | A | 10 |
| Example 107 | acetyl | 2.35/2.41 | A | 18 | acetyl | 2.72/2.81 | A | 10 |

| | All Cellulose Acylate Resin Dopes | | | |
|---|---|---|---|---|
| | Cellulose Acylate | (cellulose acylate resin dope | | |
| | Resin Dopes | produced from scrapped material | value of (Δ substitution | |
| | Produced from | of film of Example and | degree) × (area ratio) | |
| | Cotton blend ratio | Comparative Example)/(all | by HPLC-CAD | |
| | (dope 1/dope 2) | cellulose acylate resin dopes | whole film | center part |
| Comparative | — | 30 | 0 | 0 |
| Example 101 | | | | |
| Comparative | 50 | 30 | 0.03 | 0.03 |
| Example 102 | | | | |
| Example 101 | 50 | 30 | 0.05 | 0.05 |
| Comparative | 30 | 30 | 0.1 | 0.1 |
| Example 103 | | | | |
| Comparative | 30 | 30 | 0.14 | 0.14 |
| Example 104 | | | | |
| Comparative | 30 | 30 | 0.05 | 0.05 |
| Example 105 | | | | |
| Example 102 | 40 | 30 | 0.05 | 0.05 |
| Example 103 | 40 | 30 | 0.1 | 0.1 |
| Comparative | 40 | 30 | 0.15 | 0.15 |
| Example 106 | | | | |
| Comparative | 40 | 30 | 0.12 | 0.12 |
| Example 107 | | | | |
| Comparative | — | 30 | 0 | 0 |
| Example 108 | | | | |
| Example 104 | 30 | 30 | 0.09 | 0.09 |
| Example 105 | 20 | 30 | 0.12 | 0.12 |
| Comparative | 20 | 30 | 0.12 | 0.12 |
| Example 107 | | | | |
| Example 106 | 10 | 50 | 1st and 2nd, 0.02 | 1st and 2nd, 0.02 |
| | | | 1st and 3rd, 0.06 | 1st and 3rd, 0.06 |
| Example 107 | 20 | 50 | 1st and 2nd, 0.02 | 1st and 2nd, 0.02 |
| | | | 1st and 3rd, 0.05, 0.07 | 1st and 3rd, 0.05, 0.07 |

From Table 2, it is known that the optical films of the invention contain at least a cellulose acylate resin having a total degree of acyl substitution of less than 2.5, and have good peelability from the metal support in solution casting, and do not whiten, and have good optical expressibility. It is also known that, according to the optical film production method of the invention, a scrapped material is used, and therefore the production cost for the optical films of the invention is reduced and the reworkability evaluated by the above test is improved.

It has been confirmed that the films of the invention shown in Table 2 all satisfy the above-mentioned formulae (2) and (3) and the formula (A).

Further, it has been confirmed that all the cellulose acylate resins constituting the film center part of the films of the invention shown in Table 2 satisfy the above-mentioned formulae (5) and (6) and the formula (B), in which the mass abundance ratio of the cellulose acylate resin having the third largest mass abundance ratio is at least 2.5%.

In addition, it has been confirmed that the films of the invention in Table 2 all have improved heat durability and wet heat durability.

TABLE 3

| | Glycol Unit | | | | | | | | | | | |
|---|---|---|---|---|---|---|---|---|---|---|---|---|
| | terminal | | | | | | | | | | | |
| | hydroxyl | | | | | Dicarboxylic Acid Unit | | | | | | |
| | blocking ratio | EG | PG | BG | mean carbon | TPA | PA | AA | SA | mean carbon | SP Value | Molecular |
| | (%) | (%) | (%) | (%) | number | (mol %) | (mol %) | (mol %) | (mol %)) | number | (MPa^{-1/2}) | Weight |
| Additive A | 100 | 50 | 50 | 0 | 2.5 | 55 | 0 | 0 | 45 | 6.2 | 21.9 | 730 |
| Additive B | 100 | 100 | 0 | 0 | 2 | 45 | 5 | 20 | 30 | 6 | 22.3 | 840 |
| Additive C | 0 | 25 | 75 | 0 | 2.75 | 45 | 10 | 0 | 45 | 6.2 | 23.3 | 690 |
| Additive D | 0 | 50 | 50 | 0 | 2.5 | 55 | 0 | 0 | 45 | 6.2 | 23.6 | 690 |
| Additive E | 0 | 100 | 0 | 0 | 2 | 45 | 5 | 20 | 30 | 6 | 23.9 | 680 |

The present disclosure relates to the subject matter contained in Japanese Patent Application No. 2009-251231, filed on Oct. 30, 2009, and Japanese Patent Application No. 2010-208014, filed on Sep. 16, 2010, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optical film comprising at least two types of cellulose acylate resins differing from each other in the total degree of acyl substitution therein, wherein the at least two types of cellulose acylate resins include a cellulose acylate resin having a total degree of acyl substitution of less than 2.5 and a cellulose acylate resin having a total degree of acyl substitution of 2.5 or more, and of all the cellulose acylate resins constituting the optical film, the cellulose acylate resin having the largest mass abundance ratio and the cellulose acylate resin having the second largest mass abundance ratio satisfy the following formula (1):

|A−B|×(b/a)≦0.13 (1)
wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

2. The optical film according to claim 1 comprising at least three types of cellulose acylate resins differing from each other in the total degree of acyl substitution therein, wherein, of all the cellulose acylate resins constituting the optical film, the cellulose acylate resin having the largest mass abundance ratio and the cellulose acylate resin having the third largest mass abundance ratio satisfy the following formula (2), and the mass abundance ratio of the cellulose acylate resin having the third largest mass abundance ratio is at least 2.5%:

|A−C|×(c/a)<0.13 (2)
wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.

3. The optical film according to claim 1, wherein, of all the cellulose acylate resins constituting the optical film, the cellulose acylate resin having the largest mass abundance ratio and all the cellulose acylate resins having a mass abundance ratio of at least 2.5% satisfy the following formula (3):

|A−D|×(d/a)≦0.13 (3)
wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.

4. The optical film according to claim 1, wherein, of all the cellulose acylate resins constituting the optical film, all the cellulose acylate resins having a mass abundance ratio of at least 20% satisfy the following formula (A):

|P−Q|×(q/p)≦0.13 (A)
wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.

5. The optical film according to claim 1, wherein the film center part separated from both surfaces of the film by at least 20% in the film thickness direction comprises at least two types of cellulose acylate resins differing from the total degree of acyl substitution therein, and of the cellulose acylate resins constituting the film center part, the cellulose acylate resin having the largest mass abundance ratio and the cellulose acylate resin having the second largest mass abundance ratio satisfy the following formula (4):

|A−B|×(b/a)≦0.10 (4)
wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

6. The optical film according to claim 5, wherein the film center part comprises at least three types of cellulose acylate resins differing from each other in the total degree of acyl substitution therein, of all the cellulose acylate resins constituting the film center part, the cellulose acylate resin having the largest mass abundance ratio and the cellulose acylate resin having the third largest mass abundance ratio satisfy the following formula (5), and the mass abundance ratio of the cellulose acylate resin having the third largest mass abundance ratio is at least 2.5%:

|A−C|×(c/a)≦0.10 (5)
wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.

7. The optical film according to claim 5, wherein, of all the cellulose acylate resins constituting the film center part, the cellulose acylate resin having the largest mass abundance ratio and all the cellulose acylate resins having a mass abundance ratio of at least 2.5% satisfy the following formula (6)

|A−D|×(d/a)≦0.13 (6)
wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.

8. The optical film according to claim 5, wherein, of all the cellulose acylate resins constituting the film center part, all the cellulose acylate resins having amass abundance ratio of at least 20% satisfy the following formula (B):

|P−Q|×(q/p)≦0.13 (B)
wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.

9. The optical film according to claim 1, wherein any one of the cellulose acylate resin having the largest mass abundance ratio and the cellulose acylate resin having the second largest mass abundance ratio is a cellulose acylate resin having a total degree of acyl substitution of less than 2.5, and the other is a cellulose acylate resin having a total degree of acyl substitution of 2.5 or more.

10. The optical film according to claim 1, wherein the cellulose acylate resin having the largest mass abundance ratio is a cellulose acylate resin having a total degree of acyl substitution of less than 2.5, and the cellulose acylate resin having the second largest mass abundance ratio is a cellulose acylate resin having a total degree of acyl substitution of 2.5 or more.

11. The optical film according to claim 1 comprising at least two layers, wherein the mean value Z of the total degree of acyl substitution in the cellulose acylate resin constituting the layer having the largest thickness satisfies the following formula (7):
2.1<Z<2.5. (7)

12. The optical film according to claim 1 comprising at least two layers, wherein the outermost layer on at least one side of the film is a cellulose acylate layer having a total degree of acyl substitution of at least 2.5 on average.

13. The optical film according to claim 1 comprising at least three layers, wherein the outermost layer on both sides of the film is a cellulose acylate layer having a total degree of acyl substitution of at least 2.5 on average.

14. The optical film according to claim 1 containing a phosphate compound or a non-phosphate polyester compound.

15. The optical film according to claim 1, wherein the cellulose acylate resin is a cellulose acetate.

16. The optical film according to claim 1 not containing an adhesive or an agglutinant.

17. A method for producing an optical film comprising dissolving at least two types of cellulose acylate resins that differ from each other in the total degree of acyl substitution therein, in a solvent to prepare a dope, and casting the dope onto a metal support to form a film thereon, wherein the cellulose acylate resins include a cellulose acylate resin having a total degree of acyl substitution of less than 2.5 and a cellulose acylate resin having a total degree of acyl substitution of 2.5 or more, and of all the cellulose acylate resins constituting the dope, the cellulose acylate resin having the largest mass abundance ratio and the cellulose acylate resin having the second largest mass abundance ratio satisfy the following formula (1):

|A−B|×(b/a)≦0.13 (1)
wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

18. The method for producing an optical film according to claim 17, wherein the dope comprises at least three types of cellulose acylate resins differing from each other in the total degree of acyl substitution therein, of all the cellulose acylate resins constituting the dope, the cellulose acylate resin having the largest mass abundance ratio and the cellulose acylate resin having the third largest mass abundance ratio satisfy the following formula (2), and the mass abundance ratio of the cellulose acylate resin having the third largest mass abundance ratio is at least 2.5%:

|A−C|×(c/a)≦0.13 (2)
wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.

19. The method for producing an optical film according to claim 17, wherein, of all the cellulose acylate resins constituting the dope, the cellulose acylate resin having the largest mass abundance ratio and all the cellulose acylate resins having a mass abundance ratio of at least 2.5% satisfy the following formula (3):

|A−D|×(d/a)≦0.13 (3)
wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.

20. The method for producing an optical film according to claim 17, wherein, of all the cellulose acylate resins constituting the dope, all the cellulose acylate resins having a mass abundance ratio of at least 20% satisfy the following formula (A):

|P−Q|×(q/p)≦0.13 (A)
wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.

21. The method for producing an optical film according to claim 17, wherein the dopes comprise at least one dope for outermost layer and at least one dope for core layer, and the dopes are so cast successively or co-cast simultaneously that the dope for outermost layer forms the film outermost layer on the side in contact with the metal support, thereby forming a cellulose acylate laminate film.

22. The method for producing an optical film according to claim 21, wherein the dopes are so cast successively or co-cast simultaneously that the dope for outermost layer forms the film outermost layer on the side not in contact with the metal support, thereby forming a cellulose acylate laminate film.

23. The method for producing an optical film according to claim 21, wherein the dope for core layer comprises at least two types of cellulose acylate resins differing in the total degree of acyl substitution therein, of the cellulose acylate resins constituting the dope for core layer, the cellulose acylate resin having the largest mass abundance ratio and the cellulose acylate resin having the second largest mass abundance ratio satisfy the following formula (4):

|A−B|×(b/a)≦0.10 (4)
wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

24. The method for producing an optical film according to claim 21, wherein the dope for core layer comprises at least three types of cellulose acylate resins differing from each other in the total degree of acyl substitution therein, of all the cellulose acylate resins constituting the dope for core layer, the cellulose acylate resin having the largest mass abundance ratio and the cellulose acylate resin having the third largest mass abundance ratio satisfy the following formula (5), and the mass abundance ratio of the cellulose acylate resin having the third largest mass abundance ratio is at least 2.5%:

|A−C|×(c/a)≦0.10 (5)
wherein A means the total degree of acyl substitution in the cellulose acylate resin having the largest mass abundance ratio; C means the total degree of acyl substitution in the cellulose acylate resin having the third largest mass abundance ratio; a means the mass abundance ratio of the cellulose acylate resin having the largest mass abundance ratio to all the cellulose acylate resins; and c means the mass abundance ratio of the cellulose acylate resin having the third largest mass abundance ratio to all the cellulose acylate resins.

25. The method for producing an optical film according to claim 21, wherein, of all the cellulose acylate resins constituting the dope for core layer, the cellulose acylate resin having the largest mass abundance ratio and all the cellulose acylate resins having a mass abundance ratio of at least 2.5% satisfy the following formula (6):

|A−D|×(d/a)≦0.13 (6)
wherein A means the total degree of acyl substitution in the cellulose acylate resin having the largest mass abundance ratio; D means the total degree of acyl substitution in the cellulose acylate resin having a mass abundance ratio of at least 2.5%; a means the mass abundance ratio of the cellulose acylate resin having the largest mass abundance ratio to all the cellulose acylate resins; and d means the mass abundance ratio of the cellulose acylate resin having a mass abundance ratio of at least 2.5%.

26. The method for producing an optical film according to claim 21, wherein, of all the cellulose acylate resins constituting the dope for core layer, all the cellulose acylate resins having a mass abundance ratio of at least 20% satisfy the following formula (B):

|P−Q|×(q/p)≦0.13 (B)
wherein P and Q each mean the total degree of acyl substitution in the cellulose acylate resin having a mass abundance ratio of at least 20%; p and q each mean the mass abundance ratio of the cellulose acylate resin having a mass abundance ratio of at least 20%, and p≧q.

27. The method for producing an optical film according to claim 17, wherein any one of the cellulose acylate resin having the largest mass abundance ratio and the cellulose acylate resin having the second largest mass abundance ratio is a cellulose acylate resin having a total degree of acyl substitution of less than 2.5, and the other is a cellulose acylate resin having a total degree of acyl substitution of 2.5 or more.

28. The method for producing an optical film according to claim 17, wherein the cellulose acylate resin having the largest mass abundance ratio is a cellulose acylate resin having a total degree of acyl substitution of less than 2.5, and the cellulose acylate resin having the second largest mass abundance ratio is a cellulose acylate resin having a total degree of acyl substitution of 2.5 or more.

29. The method for producing an optical film according to claim 21, wherein the mean value Z of the total degree of acyl substitution in the cellulose acylate resins constituting the dope for core layer satisfies the following formula (7):
2.1<Z<2.5. (7)

30. The method for producing an optical film according to claim 21, wherein, of the dopes for outermost layer, at least the cellulose acylate resin constituting the dope for outermost layer to form the film outermost layer on the side in contact with the metal support is a cellulose acylate resin having a total degree of acyl substitution of 2.5 or more on average.

31. The method for producing an optical film according to claim 21, wherein the dope for outermost layer to form both outermost layers of the film is a cellulose acylate resin having a total degree of acyl substitution of at least 2.5 on average.

32. The method for producing an optical film according to claim 17, wherein the dope contains a phosphate compound or a non-phosphate oligomer compound.

33. The method for producing an optical film according to claim 17, wherein the cellulose acylate resin is a cellulose acetate.

34. The method for producing an optical film according to claim 17, wherein the cellulose acylate resin contains a scrapped material of a cellulose acylate resin-containing film.

35. The method for producing an optical film according to claim 34, wherein the scrapped material of a cellulose acylate resin-containing film is used as the cellulose acylate resin for the dope for core layer.

36. The method for producing an optical film according to claim 34, wherein the scrapped material of a cellulose acylate resin-containing film is a scrapped material of an optical film comprising at least two types of cellulose acylate resins differing from each other in the total degree of acyl substitution therein, wherein the at least two types of cellulose acylate resins include a cellulose acylate resin having a total degree of acyl substitution of less than 2.5 and a cellulose acylate resin having a total degree of acyl substitution of 2.5 or more, and of all the cellulose acylate resins constituting the optical film, the cellulose acylate resin having the largest mass abundance ratio and the cellulose acylate resin having the second largest mass abundance ratio satisfy the following formula (1):

|A−B|×(b/a)≦0.13 (1)
wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

37. The method for producing an optical film according to claim 34, wherein the proportion of the scrapped material of a cellulose acylate resin-containing film to all the cellulose acylate resins in the dope is from more than 10% by mass to 80% by mass.

38. The method for producing an optical film according to claim 17, wherein the metal support is SUS.

39. An optical film produced by dissolving at least two types of cellulose acylate resins that differ from each other in the total degree of acyl substitution therein, in a solvent to prepare a dope, and casting the dope onto a metal support to farm a film thereon, wherein the cellulose acylate resins include a cellulose acylate resin having a total degree of acyl substitution of less than 2.5 and a cellulose acylate resin having a total degree of acyl substitution of 2.5 or more, and of all the cellulose acylate resins constituting the dope, the cellulose acylate resin having the largest mass abundance ratio and the cellulose acylate resin having the second largest mass abundance ratio satisfy the following formula (1):

|A−B|×(b/a)≦0.13 (1)
wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

40. A polarizer comprising an optical film comprising at least two types of cellulose acylate resins differing from each other in the total degree of acyl substitution therein, wherein the at least two types of cellulose acylate resins include a cellulose acylate resin having a total degree of acyl substitution of less than 2.5 and a cellulose acylate resin having a total degree of acyl substitution of 2.5 or more, and of all the cellulose acylate resins constituting the optical film, the cellulose acylate resin having the largest mass abundance ratio and the cellulose acylate resin having the second largest mass abundance ratio satisfy the following formula (1)

|A−B|×(b/a)≦0.13 (1)
wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.

41. A liquid crystal display device comprising an optical film comprising at least two types of cellulose acylate resins differing from each other in the total degree of acyl substitution therein, wherein the at least two types of cellulose acylate resins include a cellulose acylate resin having a total degree of acyl substitution of less than 2.5 and a cellulose acylate resin having a total degree of acyl substitution of 2.5 or more, and of all the cellulose acylate resins constituting the optical film, the cellulose acylate resin having the largest mass abundance ratio and the cellulose acylate resin having the second largest mass abundance ratio satisfy the following formula (1):

|A−B|×(b/a)≦0.13 (1)
wherein A means the total degree of acyl substitution in the cellulose acylate resin having the largest mass abundance ratio; B means the total degree of acyl substitution in the cellulose acylate resin having the second largest mass abundance ratio; a means the mass abundance ratio of the cellulose acylate resin having the largest mass abundance ratio to all the cellulose acylate resins; and b means the mass abundance ratio of the cellulose acylate resin having the second largest mass abundance ratio to all the cellulose acylate resins.
